(19) United States
(12) Patent Application Publication
(10) Pub. No.: US 2019/0138887 A1
(43) Pub. Date: May 9, 2019

(54) SYSTEMS, METHODS, AND MEDIA FOR GATED RECURRENT NEURAL NETWORKS WITH REDUCED PARAMETER GATING SIGNALS AND/OR MEMORY-CELL UNITS

(71) Applicant: Board of Trustees of Michigan State University, East Lansing, MI (US)

(72) Inventor: Fathi M. Salem, Okemos, MI (US)

(21) Appl. No.: 16/178,029

(22) Filed: Nov. 1, 2018

Related U.S. Application Data
(60) Provisional application No. 62/580,028, filed on Nov. 1, 2017.

(51) Int. Cl. G06N 3/04; G06F 17/16; G06N 3/08

(52) U.S. Cl. CPC G06N 3/0445; G06F 17/27; G06N 3/084; G06F 17/16

(57) ABSTRACT

Methods, systems and media for gated recurrent neural networks (RNNs) with reduced parameter gating signals and/or memory cell units are disclosed. In some embodiments, methods for analyzing sequential data are provided, the methods comprising: providing training data to an RNN including a first gate and gating signal; calculating an array of first parameters in a first equation used to calculate values of the first gating signal, including two or fewer parameters corresponding to arrays of values; receiving input data including first data and second data, the second data comes after the first data in a sequence; providing first data to the RNN; calculating a first gating signal; generating a first output; providing second data as input to the RNN; generating a second output; and providing a third output identifying one or more characteristics of the input data based on the first output and the second output.

### CROSS-REFERENCE TO RELATED APPLICATIONS

This application claims the benefit of priority from U.S. Provisional Patent Application No. 62/580,028, filed Nov. 1, 2017, which is hereby incorporated by reference herein in its entirety for all purposes.

### STATEMENT REGARDING FEDERALLY SPONSORED RESEARCH

This invention was made with government support under 1549517 awarded by the National Science Foundation. The government has certain rights in the invention.

### BACKGROUND

Recurrent Neural Networks (RNNs) area machine learning techniques that can be used with applications that involve sequentially or temporally related data, such as speech recognition, machine translation, other natural language processing, music synthesis, etc. In the simplest type of RNNs (which is sometimes referred to as a simple Recurrent Neural Network or sRNN) units in a hidden layer receive a current input from a sequence of inputs, and generate a current output based on a set of learned weights, with the current input and output generated using the previous input in the sequence. While this type of RNN has some utility, it can be difficult to train, and is generally less useful for sequences with relatively long dependencies.

More complex types of RNNs that use gating signals have been developed that address limitations of sRNNs. These include RNNs such as: Long Short-term Memory (LSTM) RNNs, which use three gating signals per unit; Gated Recurrent Units (GRUs), RNNs which use two gating signals per unit; and Minimal Gated Units (MGUs) RNNs, which use one gating signal per unit. Each of these techniques uses non-linear gating signals that use the previous output, the current input, and learned weights to contribute to the next output of the unit. While these types of RNNs are often able to successfully perform more complex tasks than a sRNN, they also involve many more parameters and calculations at each unit which can increase the time, processing power, and/or memory required to use gated RNNs. Reducing the number of gating signals (e.g., from the three used in LSTM to the two or one used in GRU or MGU) can alter the characteristics, behavior, and consequently the performance quality of the gated RNN. In general, the LSTM RNN has exhibited the best performance among gated RNNs on a variety of benchmark public databases, while GRU RNNs have been the second best, and MGU RNNs have been third best. Note that reducing the number of gating signals also reduces the number of parameters and calculations involved, which may potentially reduce the time and/or technical requirements in using these RNNs. However, each type of gated RNN may possess unique characteristics that may render each more suitable for a class of existing or future applications. Accordingly, it may be advantageous to retain the distinct families of the three gated RNNs, while providing techniques to further reduce parameters for each family, such as by reducing parameters within the gating signals and/or memory-cell unit while retaining the architecture (and unique properties) of the distinct families.

Accordingly, systems, methods, and media for gated recurrent neural networks with reduced parameter gating signals are desirable.

### SUMMARY

In accordance with some embodiments of the disclosed subject matter, systems, methods, and media for gated recurrent neural networks with reduced parameter gating signals and/or memory-cell units are provided.

In accordance with some embodiments of the disclosed subject matter, a method for analyzing data using a reduced parameter gating signal is provided, the method comprising: receiving input data that includes at least first data and second data, wherein the first data and the second data form at least a portion of a sequence of data and the second data comes after the first data in the sequence; providing the first data as input to a recurrent neural network, wherein the recurrent neural network includes at least a first gate corresponding to a first gating signal, at least a first array of values corresponding to a first parameter in a first equation that is used to calculate values of the first gating signal was calculated based on training data provided to the recurrent neural network, and the first equation includes not more than two parameters corresponding to arrays of values; calculating a first value for the first gating signal based on the first equation using the first array of values as the first parameter; generating a first output based on the first data and the first value for the first gating signal; providing the second data as input to the recurrent neural network; generating a second output based on the second data, and the first output; and providing a third output identifying one or more characteristics of the input data based on the first output and the second output.

In some embodiments, the first parameter is an n×n matrix, and the first output is an n-element vector, wherein n≥1.

In some embodiments, the method further comprises calculating a second value for the first gating signal based on the first equation using the first parameter and the first output as input data, wherein calculating the second value comprises multiplying the first parameter and the first output.

In some embodiments, the first parameter is an n-element vector, and the first output is an n-element vector, wherein n≥1.

In some embodiments, the recurrent neural network comprises a long short-term memory (LSTM) unit

In some embodiments, the first gate is an input gate, and the first equation includes neither a weight matrix Wᵢ nor an input vector xₜ.

In some embodiments, the first gate is an input gate, and the first equation does not include a weight matrix Wᵢ, an input vector xₜ, nor a bias vector bᵢ.

In some embodiments, the first gate is an input gate, and the first equation includes a bias vector bᵢ, and does not include a weight matrix Wᵢ, an input vector xₜ, a weight matrix Uᵢ, nor an activation unit hₜ₋₁ generated at a previous step.

In some embodiments, the recurrent neural network comprises a gated recurrent unit (GRU).

In some embodiments, the first gate is an update gate, and the first equation includes neither a weight matrix W_{z} nor an input vector xₜ.

In some embodiments, the first gate is an update gate, and the first equation does not include a weight matrix W_{z}, an input vector xₜ, nor a bias vector b_{z}.

In some embodiments, the first gate is an update gate, and the first equation includes a bias vector b_{z}, and does not include a weight matrix W_{z}, an input vector xₜ, a weight matrix U_{z}, nor an activation unit hₜ₋₁ generated at a previous step.

In some embodiments, the recurrent neural network comprises a minimal gated unit (MGU).

In some embodiments, the first gate is a forget gate, and the first equation includes neither a weight matrix W_{f} nor an input vector xₜ.

In some embodiments, the first gate is a forget gate, and the first equation does not include a weight matrix W_{f}, an input vector xₜ, nor a bias vector b_{f}.

In some embodiments, the first gate is a forget gate, and the first equation includes a bias vector b_{f}, and does not include a weight matrix W_{f}, an input vector xₜ, a weight matrix U_{f}, nor an activation unit hₜ₋₁ generated at a previous step.

In some embodiments, the recurrent neural network uses no more than half as many parameter values as a second recurrent neural network that uses matrices U, W, and b to calculate a gating signal corresponding to the first gating signal.

In some embodiments, the recurrent neural network requires less memory and less time to calculate the second output than are required by the second recurrent neural network to calculate a corresponding output given the same input data.

In some embodiments, the input data is audio data, and the third output is an ordered set of words representing speech in the audio data.

In some embodiments, the input data is a first ordered set of words in a first language, and the third output is a second ordered set of words in a second language representing a translation from the first language to the second language.

In some embodiments, the third output is based on the first output, the second output, and a plurality of additional outputs that are generated subsequent to the second output and prior to the third output.

In some embodiments, the second output is calculated as hₜ=Oₜ⊙g(cₜ), where g is a non-linear activation function, Cₜ is an output of a memory cell of an LSTM unit, Oₜ is an output gate signal, and ⊙ is element-wise (Hadamard) multiplication.

In some embodiments, the second output is calculated as hₜ=(1−zₜ) ⊙hₜ₋₁+zₜ⊙ĥₜ, where ĥₜ is a candidate activation function, zₜ is an update gate signal, hₜ₋₁ is the first output, and ⊙ is element-wise (Hadamard) multiplication.

In some embodiments, the second output is hₜ=(1−fₜ) ⊙hₜ₋₁+fₜ⊙ĥₜ, where ĥₜ is a candidate activation function, fₜ is a forget gate signal, hₜ₋₁ is the first output, and ⊙ is element-wise (Hadamard) multiplication.

In some embodiments, the recurrent neural network comprises a plurality of LSTM units, and at least one gating signal has a different dimension than an output signal of a memory cell of one of the plurality of LSTM units.

In some embodiments, an update gate signal is a scalar.

In some embodiments, an update gate signal has a different dimension than a previous activation output.

In some embodiments, the update gate signal is augmented by shared elements to facilitate pointwise multiplication.

In some embodiments, a forget gate signal is a scalar.

In some embodiments, a forget gate signal includes shared elements.

In some embodiments, the recurrent neural network includes a memory cell corresponding to a memory cell signal, at least a second array of values corresponding to a second parameter in a second equation that is used to calculate values of the memory cell signal was calculated based on training data provided to the recurrent neural network, the second equation includes not more than one parameter corresponding to a multidimensional array of values, and the method further comprises: calculating a first value for the memory-cell signal; and generating the first output based on the first data, the first value for the first gating signal, and the first value for the memory-cell signal.

In accordance with some embodiments of the disclosed subject matter, a system for analyzing data using a reduced parameter gating signal is provided, the system comprising: a processor that is programmed to: receive input data that includes at least first data and second data, wherein the first data and the second data form at least a portion of a sequence of data and the second data comes after the first data in the sequence; provide the first data as input to a recurrent neural network, wherein the recurrent neural network includes at least a first gate corresponding to a first gating signal, at least a first array of values corresponding to a first parameter in a first equation that is used to calculate values of the first gating signal was calculated based on training data provided to the recurrent neural network, and the first equation includes not more than two parameters corresponding to arrays of values; calculate a first value for the first gating signal based on the first equation using the first array of values as the first parameter; generate a first output based on the first data and the first value for the first gating signal; providing the second data as input to the recurrent neural network; generate a second output based on the second data, and the first output; and provide a third output identifying one or more characteristics of the input data based on the first output and the second output.

In accordance with some embodiments of the disclosed subject matter, a non-transitory computer readable medium containing computer executable instructions that, when executed by a processor, cause the processor to perform a method for analyzing data using a reduced parameter gating signal is provided, the method comprising: receiving input data that includes at least first data and second data, wherein the first data and the second data form at least a portion of a sequence of data and the second data comes after the first data in the sequence; providing the first data as input to a recurrent neural network, wherein the recurrent neural network includes at least a first gate corresponding to a first gating signal, at least a first array of values corresponding to a first parameter in a first equation that is used to calculate values of the first gating signal was calculated based on training data provided to the recurrent neural network, and the first equation includes not more than two parameters corresponding to arrays of values; calculating a first value for the first gating signal based on the first equation using the first array of values as the first parameter; generating a first output based on the first data and the first value for the first gating signal; providing the second data as input to the recurrent neural network; generating a second output based on the second data, and the first output; and providing a third output identifying one or more characteristics of the input data based on the first output and the second output.

In accordance with some embodiments of the disclosed subject matter, a method for analyzing sequential data using a reduced parameter gating signal is provided, the method comprising: providing training data to a recurrent neural network including at least a first gate corresponding to a first gating signal; calculating, based on the training data, at least a first array of values as a first parameter in a first equation used to calculate values of the first gating signal, wherein the first equation includes not more than two parameters corresponding to arrays of values; receiving input data that includes at least first data and second data, wherein the first data and the second data form at least a portion of a sequence of data and the second data comes after the first data in the sequence; providing the first data as input to the recurrent neural network; calculating a first value for the first gating signal based on the first equation using the first array of values as the first parameter; generating a first output based on the first data and the first value for the first gating signal; providing the second data as input to the recurrent neural network; generating a second output based on the second data, and the first output; and providing a third output identifying one or more characteristics of the input data based on the first output and the second output.

In accordance with some embodiments of the disclosed subject matter, a method for analyzing data using a reduced parameter gating signal is provided, the method comprising: receiving input data that includes at least first data and second data, wherein the first data and the second data form at least a portion of a sequence of data and the second data comes after the first data in the sequence; providing the first data as input to the recurrent neural network, wherein the recurrent neural network comprises a long short-term memory unit including at least a first gate corresponding to a first gating signal, and a memory cell corresponding to a memory-cell signal, a least a first array of values corresponding to a first parameter in a first equation that is used to calculate values of the first gating signal was calculated based on training data provided to the recurrent neural network, a second array of values corresponding to a second parameter in a second equation that is used to calculate values of the memory-cell signal was calculated based on the training data provided to the recurrent neural network, the first equation includes not more than two parameters corresponding to arrays of values, and the second equation includes not more than one parameter corresponding to a multidimensional array of values; calculating a first value for the first gating signal based on the first equation using the first array of values as the first parameter; calculating a first value for the memory-cell signal based on the second equation using the second array of values as the second parameter; generating a first output based on the first data, the first value for the first gating signal, and the first value for the memory-cell signal; providing the second data as input to the recurrent neural network; generating a second output based on the second data, and the first output; and providing a third output identifying one or more characteristics of the input data based on the first output and the second output.

In accordance with some embodiments of the disclosed subject matter, a system for analyzing data using a reduced parameter gating signal is provided, the system comprising: a processor that is programmed to: receive input data that includes at least first data and second data, wherein the first data and the second data form at least a portion of a sequence of data and the second data comes after the first data in the sequence; provide the first data as input to the recurrent neural network, wherein the recurrent neural network comprises a long short-term memory unit including at least a first gate corresponding to a first gating signal, and a memory cell corresponding to a memory-cell signal, a least a first array of values corresponding to a first parameter in a first equation that is used to calculate values of the first gating signal was calculated based on training data provided to the recurrent neural network, a second array of values corresponding to a second parameter in a second equation that is used to calculate values of the memory-cell signal was calculated based on the training data provided to the recurrent neural network, the first equation includes not more than two parameters corresponding to arrays of values, and the second equation includes not more than one parameter corresponding to a multidimensional array of values; calculate a first value for the first gating signal based on the first equation using the first array of values as the first parameter; calculate a first value for the memory-cell signal based on the second equation using the second array of values as the second parameter; generate a first output based on the first data, the first value for the first gating signal, and the first value for the memory-cell signal; providing the second data as input to the recurrent neural network; generate a second output based on the second data, and the first output; and provide a third output identifying one or more characteristics of the input data based on the first output and the second output.

In accordance with some embodiments of the disclosed subject matter, a non-transitory computer readable medium containing computer executable instructions that, when executed by a processor, cause the processor to perform a method for analyzing data using a reduced parameter gating signal is provided, the method comprising: receiving input data that includes at least first data and second data, wherein the first data and the second data form at least a portion of a sequence of data and the second data comes after the first data in the sequence; providing the first data as input to the recurrent neural network, wherein the recurrent neural network comprises a long short-term memory unit including at least a first gate corresponding to a first gating signal, and a memory cell corresponding to a memory-cell signal, a least a first array of values corresponding to a first parameter in a first equation that is used to calculate values of the first gating signal was calculated based on training data provided to the recurrent neural network, a second array of values corresponding to a second parameter in a second equation that is used to calculate values of the memory-cell signal was calculated based on the training data provided to the recurrent neural network, the first equation includes not more than two parameters corresponding to arrays of values, and the second equation includes not more than one parameter corresponding to a multidimensional array of values; calculating a first value for the first gating signal based on the first equation using the first array of values as the first parameter; calculating a first value for the memory-cell signal based on the second equation using the second array of values as the second parameter; generating a first output based on the first data, the first value for the first gating signal, and the first value for the memory-cell signal; providing the second data as input to the recurrent neural network; generating a second output based on the second data, and the first output; and providing a third output identifying one or more characteristics of the input data based on the first output and the second output.

In some embodiments, the memory-cell signal is cₜ=fₜ ⊙cₜ₋₁+iₜ⊙\tilde{c}ₜ, where fₜ is a forget gate signal, iₜ is an input gate signal, cₜ₋₁ is the first value for the cell signal, \tilde{c}ₜ=g(W_{c}xₜ+u_{c}⊙hₜ₋₁), g is a non-linear activation function, W_{c} is a weight matrix, xₜ is the second data, u_{c} is a weighting vector, hₜ₋₁ is the first output, and ⊙ is element-wise (Hadamard) multiplication.

In some embodiments, the memory-cell signal is cₜ=fₜ⊙cₜ₋₁+iₜ ⊙\tilde{c}ₜ, where fₜ is a forget gate signal, iₜ is an input gate signal, cₜ₋₁ is the first value for the memory-cell signal, \tilde{c}ₜ=g(W_{c}xₜ+u_{c} ⊙hₜ₋₁+b_{c}), g is a non-linear activation function, W_{c} is a weight matrix, xₜ is the second data, u_{c} is a weighting vector, hₜ₋₁ is the first output, ⊙ is element-wise (Hadamard) multiplication, and b_{c} is a bias vector.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for gated RNNs with reduced parameter gating signals is shown in accordance with some embodiments of the disclosed subject matter.

FIG. 2 shows an example of hardware that can be used to implement a server and computing device in accordance with some embodiments of the disclosed subject matter.

FIG. 3 shows an example of a system for gated RNNs with reduced parameter gating signals.

FIG. 4 shows an example of previously proposed gated RNN units using common parameters.

FIG. 5 shows an example of variants of the RNN units shown in FIG. 4 in accordance with some embodiments of the disclosed subject matter.

FIG. 6 shows another example of variants of the RNN units shown in FIG. 4 in accordance with some embodiments of the disclosed subject matter.

FIG. 7 shows yet another example of variants of the RNN units shown in FIG. 4 in accordance with some embodiments of the disclosed subject matter

FIG. 8 shows an example of a process for training and using a gated RNNs with reduced parameter gating signals in accordance with some embodiments of the disclosed subject matter.

FIGS. 9A to 9C show examples of results generated by recurrent neural networks using LSTM variants in accordance with some embodiments of the disclosed subject matter.

FIGS. 10A to 10E show examples of results generated by RNNs using GRU variants in accordance with some embodiments of the disclosed subject matter.

FIGS. 11A to 11C show examples of results generated by RNNs using MGU variants in accordance with some embodiments of the disclosed subject matter.

FIG. 12 shows still another example of variants of the RNN units shown in FIG. 4 in accordance with some embodiments of the disclosed subject matter.

FIG. 13 shows a further example of variants of the RNN units shown in FIG. 4 in accordance with some embodiments of the disclosed subject matter.

FIG. 14 shows another further example of variants of the RNN units shown in FIG. 4 in accordance with some embodiments of the disclosed subject matter.

FIG. 15 shows yet another further example of variants of the RNN units shown in FIG. 4 in accordance with some embodiments of the disclosed subject matter.

FIG. 16 shows still another further example of variants of the RNN units shown in FIG. 4 in accordance with some embodiments of the disclosed subject matter.

FIG. 17 shows an additional example of variants of the RNN units shown in FIG. 4 in accordance with some embodiments of the disclosed subject matter.

FIG. 18 shows another additional example of variants of the RNN units shown in FIG. 4 in accordance with some embodiments of the disclosed subject matter.

### DETAILED DESCRIPTION

In accordance with various embodiments, mechanisms (which can, for example, include systems, methods, and media) for gated RNNs with reduced parameter gating signals are provided.

In some embodiments, the mechanisms described herein can use gating signals for various gated RNNs that have fewer parameters, and consequently have fewer calculations and less memory to generate comparable results. These reduced parameter gating signals can be used to retrain existing gated RNNs, and can provide comparable results more quickly and/or while using fewer compute resources. In some embodiments, the trained gated RNN can analyze input received in the form of sequential data (e.g., to detect, classify, recognize, infer, predict, translate, etc.).

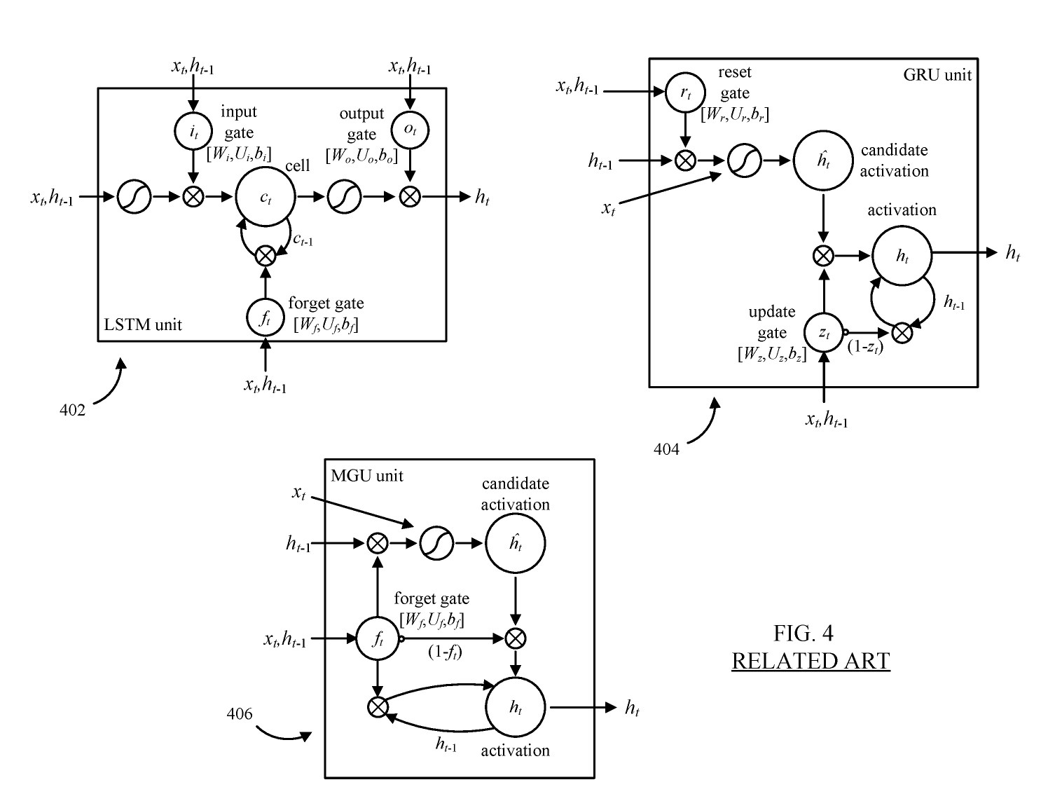

In some embodiments, the removal of any particular parameter(s) can eliminate the adaptive computational effort for estimating that parameter(s), can eliminate the need to store that parameter(s), and/or can eliminate one or more intermediate steps associated with that parameter(s) during a training phase. For example, many RNN-based machine learning systems use multiple cascaded RNNs, such that a reduction in the number of parameters not only has an effect on the amount of time required to train a single RNN unit, but has an effect that scales when applied to multiple interconnected RNNs. In a more particular example, certain RNN techniques can include 4 to 8 cascaded LSTM RNNs. In general, using the mechanisms described herein can facilitate a reduction in the amount of memory and/or CPU/GPU resources used to train RNNs, and to use RNNs. Additionally or alternatively, using the mechanisms described herein can facilitate implementation of more complex RNNs (e.g., having more interconnections, more cascaded units, etc.) while using a similar amount of resources (e.g., memory, compute resources, time, etc.). For example, in some embodiments, the mechanisms described herein can be used to implement an entire recurrent neural network, or a block within a neural network that includes conventional layers (e.g., including units such as those described in connection with FIG. 4).

In accordance with some embodiments of the disclosed subject matter, mechanisms described herein can be used in connection with various different architectural forms and/or families of RNNs. In general, the mechanisms described herein can be used to reduce the number of parameters used by a particular architecture. For example, as described below in connection with long short term memory (LSTM) RNNs, the state is generally reflected in an output signal (e.g., hₜ) and/or a cell signal (e.g., cₜ). In a more particular example, certain redundancies can be eliminated and parameters can be reduced by eliminating the output signal (e.g., hₜ) from one or more of the gating signals and/or from the memory-cell signal. In another more particular example, the state signal can carry information about the history of the external input, which can eliminate the need to use an explicit current sample of the external input (e.g., xₜ) in the “control” gating signals. This can also eliminate a source of noise, as the instantaneous external input may be noisy or an outlier sample, while the history of the external input signal is more likely to have a higher signal to noise ratio. In yet another more particular example, because the history of the update of the parameters (e.g., weights and/or biases) depend implicitly on the state (or back-propagating co-state), parameters can be reduced by using one or the other in the “control” gating signals. As still another more particular example, because the external input is multiplied by a weight matrix to achieve signal-mixing (e.g., signal scaling and rotation) of the incoming signals, there is less need to also mix the state, and simple scaling may suffice in many cases. Accordingly, a two-dimensional weight matrix can be replaced by a one dimensional weight vector. This can allow for point-wise multiplication to be used to determine the state in the memory-cell equations and in the gating equations, rather than regular matrix multiplication, which can reduce the number of calculations that are performed substantially (e.g., as described below). As a further particular example, reduced forms of the gating signals (equations) can be combined with reduced forms of the memory-cell signal (equations) to achieve all permutations of reduced form models in terms of graded reduction in (adaptive) parameters.

In general, Recurrent Neural Networks (RNNs) (gated and un-gated) use signals that can include an external input (xₜ), an activation (sometimes referred to as a hidden unit) and/or a memory cell (cₜ), and, in some cases, functions of such signals. Each signal can be multiplied by an array of parameters and the contributions of each can be summed. RNNs can also include a bias parameter (which is generally implemented as a vector). Linear weighted sum combinations can drive the simple RNN (e.g., as described below) and gating signals in (gated) RNNs. Gating signals in Gated RNNs can incorporate the previous hidden unit or state, the present input signal, and a bias, which can enable the Gated RNN to learn (e.g., sequence-to-sequence mappings). Each gating signal (which can be represented by an equation) replicates a simple RNN structure with sigmoidal nonlinearity to retain the gating signal between 0 and 1. Parameters in Gated RNNs are also generally updated during training using one of a family of stochastic backpropagation through time (BTT) gradient descent, with an objective of minimizing a specified loss function.

Gating signals can be characterized as control containing parameters to be adaptively determined by minimizing an Objective/Loss function. To restrict the control signal range to be within (0, 1), the control signal can be characterized in a general form. For example, for tractable and modular implementations, the mechanisms described herein can be applied to all gating signals uniformly. Accordingly, a description of a modified form of one of the gating signals (e.g., the i-th gating signal) can be replicated in all other gating signals.

In general, a gating signal is driven by three terms, (i) a hidden or a state variable multiplied by a matrix, (ii) a current external sample input multiplied by a matrix, and (iii) a bias vector. The mechanisms described herein can be based on combinations of the absence or presence of each term: there are a total of eight possible combinations of these terms (e.g., none, i, ii, iii, i and ii, i and iii, etc.). Conventional LSTMs use all of the terms, while a trivial combination when all terms are absent leads to a gating signal of zeros (e.g., some gating signals in an RNN may be shut off entirely), leaving six other possible combinations. As the state generally captures all information about prior input sequences, it is plausible to drop the instantaneous input sample, as an instantaneous sample may be an outlier or very noisy sample and thus may adversely affect the contributions of the gating control signal in the training process. Accordingly, it is advantageous in many cases to use the state, which contains filtered information about the sequence over its duration, and discard the current input sample in the gating signals. If the external input signals are excluded from the gates, the variations are reduced to three non-trivial combinations (e.g., i, ii, and iii).

For “memory-cell” equations, parameter reductions can be applied to the component associated with the sRNN. In this component, the (external) input signal enters multiplied via a matrix. Regular matrix multiplication provides scaling and mixing of the components of the external input sample. This term can be retained as is (e.g., in order to provide scaling and rotation (mixing) of the external input sample). The second term involves the hidden variable which is a function of (or representing) the (internal) state, which can capture the history (or profile) of the input sequence (over its duration). Accordingly, regular matrix multiplication can be replaced by point-wise (Hadamard) multiplication to provide scaling but not rotation (mixing), as the external input will be mixed at every instant, its history will be (scaled and) mixed as well due to the sequence process.

A state variable can, in general, summarize the information of a Gated RNN up to the present (or previous) “time” step (which may correspond to a particular time such as in an audio recording, or simply a previous sample in a sequence such as a previous character, a previous word, etc.). The state thus can include the information inherent in the (times-series) sequence of input samples over their duration. Accordingly, all information regarding the current input and the previous hidden states can be reflected in the most recent state variable, and thus, the internal state can provide a great deal of information that can be used by the Gated RNN in the absence of other information that is typically used. Moreover, adaptive updates of the parameters, including the biases, generally include components of the internal state of the system.

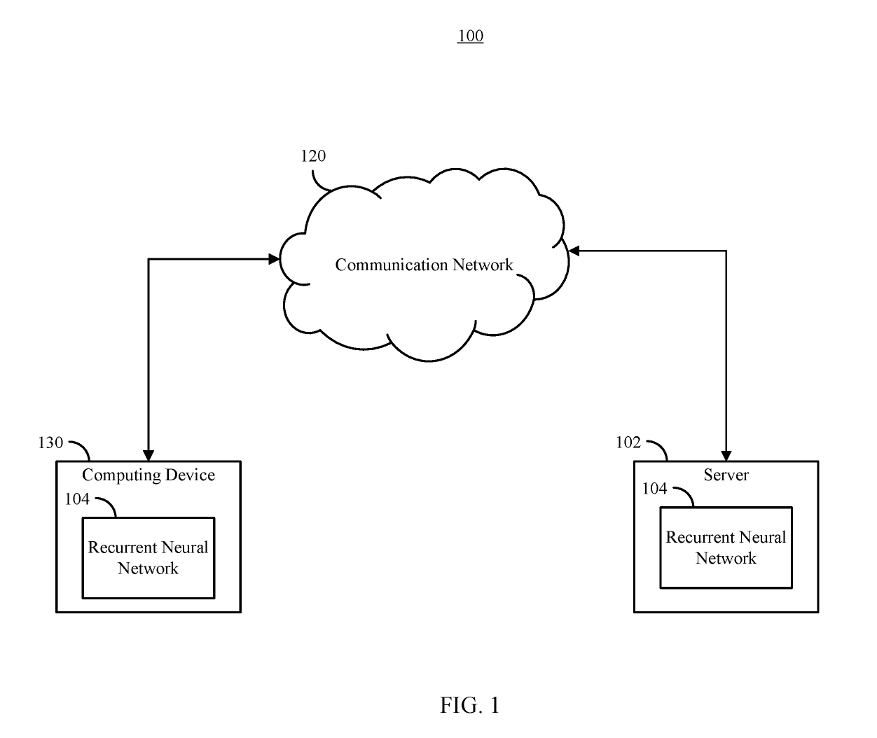

Turning to FIG. 1, an example 100 of a system for gated RNNs with reduced parameter gating signals is shown in accordance with some embodiments of the disclosed subject matter. As shown in FIG. 1, a server (or other processing unit) 102 can execute one or more applications to provide access to a trained RNN 104 that can be implemented using, for example, one or more LSTM units, one or more GRUs, and/or one or more MGUs. In some embodiments, RNN 104 can receive an input (e.g., one or more words to be translated, a sample of speech, a sample of music, a prediction or sequence problem, regressions, etc.) and can return/generate output indicative of a pattern recognized in the input. For example, if the input is a string of text in a first language, RNN 104 can output a string of text in a second language as a machine translation of the first string of text into the second language.

In some embodiments, server 102 and/or RNN 104 can receive the input over a communication network 120. In some embodiments, such information can be received from any suitable computing device, such as computing device 130. For example, computing device 130 can receive the input through an application being executed by computing device 130, such as by recording a portion of audio that includes speech, by receiving text and/or a selection of text to be translated, etc. In such an example, computing device can communicate the input over communication network 120 to server 102 (or another server that can provide the input to server 102). As another example, in some embodiments, computing device 130 can provide the input via a user interface provided by server 102 and/or another server. In such an example, computing device 130 can access a web page (or other user interface) provided by server 102, and can use the web page to provide the input. Additionally or alternatively, in some embodiments, server 102 and/or another server can provide the input. In some embodiments, RNN 104 can be executed by computing device 130, which can use RNN 104 offline (i.e., without having network access to send input to server 102).

In some embodiments, communication network 120 can be any suitable communication network or combination of communication networks. For example, communication network 120 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), a wired network, etc. In some embodiments, communication network 120 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc. In some embodiments, server 102 and/or computing device 130 can be any suitable computing device or combination of devices, such as a desktop computer, a laptop computer, a smartphone, a tablet computer, a wearable computer, a server computer, a virtual machine being executed by a physical computing device, etc.

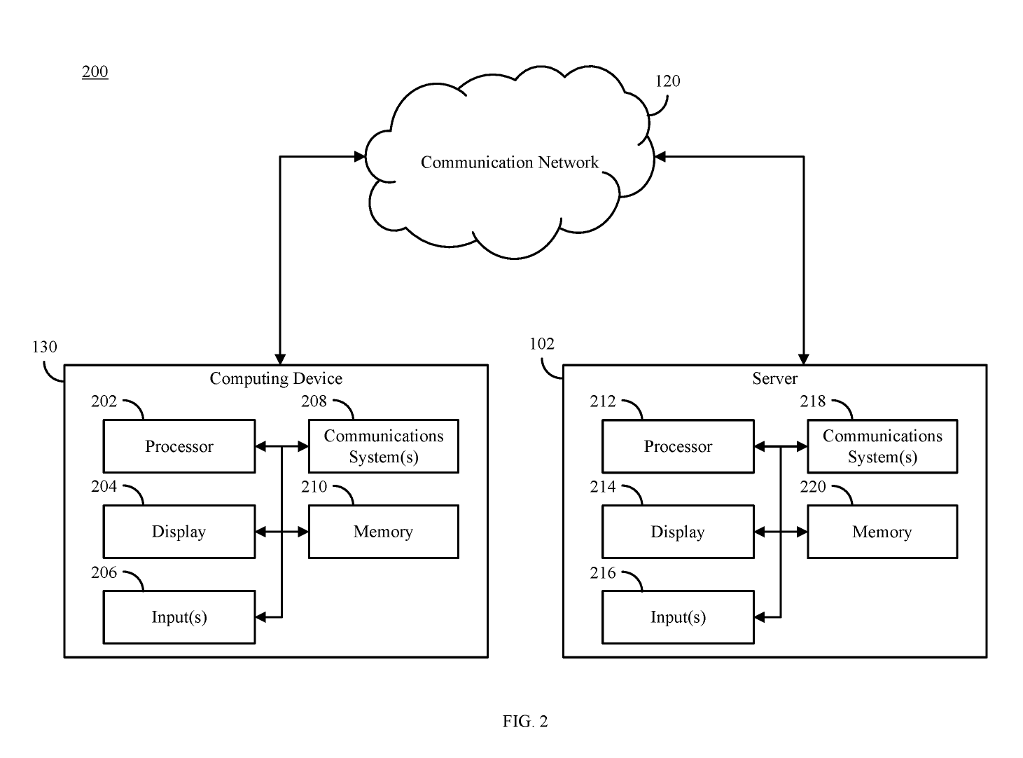

FIG. 2 shows an example 200 of hardware that can be used to implement server 102 and computing device 130 in accordance with some embodiments of the disclosed subject matter. As shown in FIG. 2, in some embodiments, computing device 130 can include a processor 202, a display 204, one or more inputs 206, one or more communication systems 208, and/or memory 210. In some embodiments, processor 202 can be any suitable hardware processor or combination of processors, such as a central processing unit, a graphics processing unit, an FPGA, etc. In some embodiments, display 204 can include any suitable display devices, such as a computer monitor, a touchscreen, a television, etc. In some embodiments, inputs 206 can include any suitable input devices and/or sensors that can be used to receive user input, such as a keyboard, a mouse, a touchscreen, a microphone, a camera, etc.

In some embodiments, communications systems 208 can include any suitable hardware, firmware, and/or software for communicating information over communication network 120 and/or any other suitable communication networks. For example, communications systems 208 can include one or more transceivers, one or more communication chips and/or chip sets, etc. In a more particular example, communications systems 208 can include hardware, firmware and/or software that can be used to establish a Wi-Fi connection, a Bluetooth connection, a cellular connection, an Ethernet connection, etc.

In some embodiments, memory 210 can include any suitable storage device or devices that can be used to store instructions, values, etc., that can be used, for example, by processor 202 to present content using display 204, to communicate with server 102 via communications system(s) 208, etc. Memory 210 can include any suitable volatile memory, non-volatile memory, storage, or any suitable combination thereof. For example, memory 210 can include RAM, ROM, EEPROM, one or more flash drives, one or more hard disks, one or more solid state drives, one or more optical drives, etc. In some embodiments, memory 210 can have encoded thereon a computer program for controlling operation of computing device 130. In such embodiments, processor 202 can execute at least a portion of the computer program to present content (e.g., user interfaces, tables, graphics, etc.), receive content from server 102, transmit information to server 102, etc.

In some embodiments, server 102 can be implemented using one or more servers 102 that can include a processor 212, a display 214, one or more inputs 216, one or more communications systems 218, and/or memory 220. In some embodiments, processor 212 can be any suitable hardware processor or combination of processors, such as a central processing unit, a graphics processing unit, etc. In some embodiments, display 214 can include any suitable display devices, such as a computer monitor, a touchscreen, a television, etc. In some embodiments, inputs 216 can include any suitable input devices and/or sensors that can be used to receive user input, such as a keyboard, a mouse, a touchscreen, a microphone, etc. In some embodiments, server 102 can be a mobile device.

In some embodiments, communications systems 218 can include any suitable hardware, firmware, and/or software for communicating information over communication network 120 and/or any other suitable communication networks. For example, communications systems 218 can include one or more transceivers, one or more communication chips and/or chip sets, etc. In a more particular example, communications systems 218 can include hardware, firmware and/or software that can be used to establish a Wi-Fi connection, a Bluetooth connection, a cellular connection, an Ethernet connection, etc.

In some embodiments, memory 220 can include any suitable storage device or devices that can be used to store instructions, values, etc., that can be used, for example, by processor 212 to present content using display 214, to communicate with one or more computing devices 130, etc. Memory 220 can include any suitable volatile memory, non-volatile memory, storage, or any suitable combination thereof. For example, memory 220 can include RAM, ROM, EEPROM, one or more flash drives, one or more hard disks, one or more solid state drives, one or more optical drives, etc. In some embodiments, memory 220 can have encoded thereon a server program for controlling operation of server 102. In such embodiments, processor 212 can execute at least a portion of the server program to transmit information and/or content (e.g., results of a database query, a user interface, etc.) to one or more computing 130, receive information and/or content from one or more computing devices 130, receive instructions from one or more devices (e.g., a personal computer, a laptop computer, a tablet computer, a smartphone, etc.), etc.

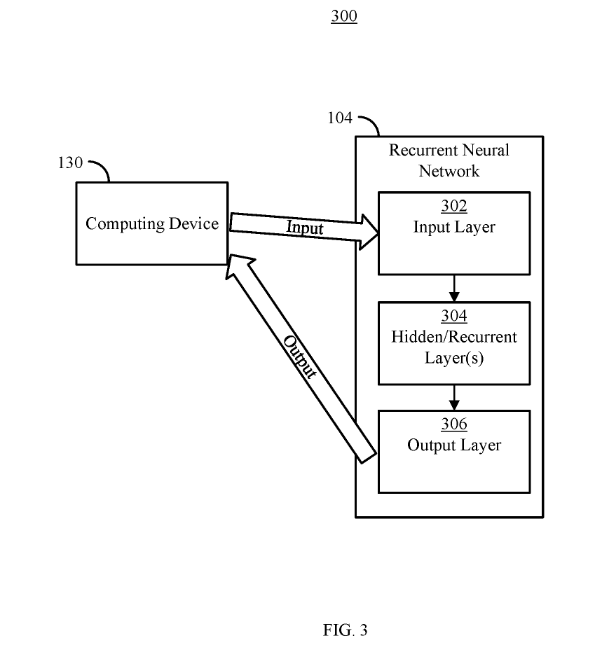

FIG. 3 shows an example of a system 300 for gated RNNs with reduced parameter gating signals. As shown in FIG. 3, computing device 130 (and/or any other computing device, such as server 102) can provide input data to an input layer 302 that can, for example, convert the input into a form (e.g., a vector of dimension one or more) that can be used by units in the recurrent neural network. Input layer 302 can provide the input to a hidden/recurrent layer 304 that can include one or more gated RNN units in any suitable configuration. For example, hidden/recurrent layer 304 can include one or more LSTM units, one or more GRUs, and/or one or more MGUs, which can analyze input data and provide an output (e.g., based on the input data and one or more gating signals). Outputs from hidden/recurrent layer 304 can be provided to another hidden/recurrent layer (not shown) and/or an output layer 306 that can generate and/or provide output that is useful to computing device 130. For example, output layer 306 can use a sequence of outputs of hidden/recurrent layer 304 (e.g., which are provided as a sequence of vectors of dimension one or more) that performs a machine translation function to generate a string of text that corresponds to the sequence of outputs. In some embodiments, output layer 306 is a feedforward layer, which does not directly provide input back to any cells in hidden/recurrent layer 304. Note that hidden/recurrent layer 304 can include many units arranged in any suitable configuration, and can include other recurrent or non-recurrent layers (e.g., projection layers). However, the operation of each individual unit of a particular RNN operates generally the same, but uses different weights.

FIG. 4 shows examples of gated RNN units using common parameters. In general, a simple RNN has a recurrent hidden state that can, for example, be represented as:

hₜ=g(Wxₜ+Uhₜ₋₁+b), (1)

where xₜ is an (external) m-dimensional input vector at time (or sequence number) t, hₜ is an n-dimensional hidden state, g is an (element-wise) activation function (e.g., the logistic function, the hyperbolic tangent function, or the rectified Linear Unit), and W, U, and b are appropriately sized parameters (two weight matrices W and U, and a bias vector b). More particularly, W can be an n×m matrix, U can be an n×n matrix, and b can be an n×1 matrix (i.e., a vector). While a simple recurrent network that uses the relationship shown in Equation 1 may perform satisfactorily in some tasks involving short sequences, it is difficult to accurately capture longer term dependencies using such a simple RNN. This is at least in part because the stochastic gradients tend to either vanish or explode when longer sequences are used. Gated RNNs are generally better at handling longer sequences, with the gate signals being used to modify the input signals and/or feedback (e.g., previous output), which can constrain the gradient values from diverging toward larger values or converging to zero inappropriately. For example, the gate signals can, in effect, regulate the gradient values.

In general, multiple different types of RNNs have been proposed, including LSTM, GRU, and MGU RNNs. Among the most widespread is LSTM RNN, which utilizes a “memory” cell that can maintain its state value over a relatively long period of time (e.g., over multiple time periods, elements in a sequence, etc.), and a gating mechanism that contains three non-linear gates: an input gate, an output gate, and a forget gate. In LSTM units, the gates role is generally to regulate the flow of signals into and out of the cell, in order to be effective in regulating long-range dependencies and facilitate successful RNN training. Modifications have been proposed to attempt to improve performance. For example, “peephole” connections have been added to the LSTM unit that can connect the memory cell to the gates so as to infer precise timing of the outputs. As another example, additional layers have been added, such as two recurrent and non-recurrent projection layers between the LSTM units layer and the output layer, which can facilitate significantly improved performance in a large vocabulary speech recognition task.

As shown in FIG. 4, LSTM unit 402 is an example implementation of an LSTM unit using common gating signals (but no “peephole” connections). In LSTM unit 402, the dynamic equations can be represented, for example, as follows:

iₜ=σ(Uᵢhₜ₋₁Wᵢxₜ+bᵢ), (2)

fₜ=σ(U_{f}hₜ₋₁W_{f}xₜ+b_{f}), (3)

oₜ=σ(Uₒhₜ₋₁Wₒxₜ+bₒ), (4)

cₜ=fₜ⊙cₜ₋₁+iₜ⊙tanh(U_{c}hₜ₋₁+W_{c}xₜ+b_{c}), (5)

hₜ=Oₜ⊙tanh(cₜ). (6)

In Equations (2) to (4), iₜ, fₜ, and Oₜ are the input gate, forget gate, and output gate, respectively, and are each an n-dimensional vector at stage/time step t. Note that each of the gate signals includes the logistic nonlinearity, σ, and accordingly has a value within the range of 0 and 1. The n-dimensional cell state vector, cₜ, and the n-dimensional hidden activation unit, hₜ, at stage/time step t are represented by Equations (5) and (6). The input vector, xₜ, is an m-dimensional vector, tanh is the nonlinearity expressed here as the hyperbolic tangent function, and ⊙ (in Equations (5) and (6)) represents a point-wise (i.e. Hadamard) multiplication operator. Note that the gate signals (i, f and o), cell (c), and activation (h) all have the same number of elements (i.e., are each an n-dimensional vector). The parameters used in LSTM unit 402 are matrices (U_{*}, W_{*}) and biases (b_{*}) in Equations (2)-(6). Accordingly, the total number of parameters (i.e., the number of all the elements in U_{*}, W_{*} and b_{*},), which can be expressed as N, can be determined using the following relationship:

N=4×(m×n+n²+n), (7)

where m is the dimension of input vector xₜ and n is the dimension of the cell vector Cₜ. This total number N is a four-fold increase over the number of parameters used by a sRNN. Note that, although the input gate, forget gate, and output gate (and gates described below in connection with GRU and MGU cells) are described as being n-dimensional vectors (i.e., equal-sized vectors that have the same dimension as the cell state vector cₜ), this is merely an example, and gates described herein can have different dimensions of any suitable size, including a dimension of one (i.e., a scalar). Additionally, although W and U are described above in connection with the gating signals as matrices of particular dimensions (i.e., an n×m matrix, and an n×n matrix, respectively), and b is described as a vector of particular dimension (i.e., n×1), these are merely examples, and these parameters can have any suitable size or sizes (e.g., corresponding to a dimension of the gating signal, which can be an integer between 1 and n). For example, the gating signal can be a scalar quantity. In such an example, the gating signal parameters W, U and b can be a 1×m, 1×n, and 1×1 matrix (i.e., scalar), respectively. Note that a matrix is sometimes described as an array of values, which can have any combination of dimensions (e.g., a scalar, a column vector, a row vector, a square matrix, a matrix of dimensions a×b (e.g., a rectangular matrix), etc.). Note that if one operand of what is identified above as a pointwise multiplication operation is a scalar, the pointwise multiplication operation can be replaced with a scalar multiplication operation (i.e., if fₜ is a scalar, fₜ ⊙cₜ₋₁ can be expressed as fₜ×cₜ₋₁). Similarly, if the two operands of what is identified above as a pointwise multiplication operation are both matrices, but have different sizes, a different operation can be used to achieve a compatible multiplication. For example, if fₜ is a vector of dimension 3×1, and the cell state vector cₜ has a dimension of n=5, then the vector fₜ can be augmented to become a 5×1 vector f′ₜ using elements in the original vector fₜ to augment its size. Then, a point-wise multiplication between fₜ and cₜ₋₁ can be carried out (i.e. f′ₜ ⊙cₜ₋₁). Such a procedure of augmenting one matrix to match the size of the other by replicating identical elements can sometimes be referred to as sharing elements. Using such a procedure, pointwise multiplication of equal size matrices (or vectors) is well defined.

Note that adding more components to the LSTM unit (e.g., by adding peephole connection) or network (e.g., by adding projection layers) may complicate the learning computational process. GRU and MGU can be used as simplified variants of LSTM-based RNNs. GRU units replace the input gate, forget gate, and output gate of the LSTM unit with an update gate zₜ and a reset gate rₜ. Comparisons between LSTM and GRU RNNs, have shown that GRU RNNs performed comparably or even exceeded the performance of LSTM on specific datasets. Additionally, MGU, which has a minimum of one gate (i.e., the forget gate, fₜ), can be derived from GRU by replacing the update and reset gates by a single gate in the GRU unit. Comparisons of a GRU RNN and an MGU RNN showed that performance was comparable (in terms of testing accuracy).

As shown in FIG. 4, GRU unit 404 is an example implementation of a GRU unit using common gating signals. In GRU 404, the dynamic equations can be represented as follows:

zₜ=σ(U_{z}hₜ₋₁+W_{z}xₜ+b_{z}), (8)

rₜ=σ(Uᵣhₜ₋₁+Wᵣxₜ+bᵣ), (9)

hₜ=(1−zₜ) ⊙hₜ₋₁+zₜ⊙ĥₜ, (10)

ĥₜ=tanh(Uₕ(rₜ⊙hₜ₋₁)+Wₕxₜ+bₕ). (11)

In Equations (8) and (9), Zₜ and rₜ are the update gate and reset gate, respectively, and are each an n-dimensional vector at time step t. Note that each of the gate signals includes the logistic nonlinearity, σ, and accordingly has a value within the range of 0 and 1. The n-dimensional activation vector, hₜ, and the n-dimensional candidate activation unit, ĥₜ, at time step t are represented by Equations (10) and (11). The input vector, xₜ, is an m-dimensional vector, tanh is the nonlinearity expressed here as the hyperbolic tangent function, and ⊙ (in Equations (10) and (11)) represents a point-wise (i.e., Hadamard) multiplication operator. Note that the gate signals (z and r), activation (h), and candidate activation (ĥ) all have the same number of elements (i.e., are each an n-dimensional vector). The parameters used in GRU 404 are matrices (U_{*},W_{*}) and biases (b_{*}) in Equations (8), (9) and (11). Accordingly, the total number of parameters (i.e., the number of all the elements in U_{*},W_{*} and b_{*}(e.g., N)) can be determined using the following relationship:

N=3×(m×n+n²+n), (12)

where m is the dimension of input vector xₜ and n is the dimension of the cell vector cₜ, which is a three-fold increase over the number of parameters used by a sRNN unit, but a savings of (m×n+n²+n) parameters compared to LSTM.

As shown in FIG. 4, MGU unit 406 is an example implementation of an MGU unit using common gating signals. In MGU 406, the dynamic equations can be represented as follows:

fₜ=σ(U_{f}hₜ₋₁+W_{f}xₜ+b_{f}), (13)

hₜ=(1−fₜ) ⊙hₜ₋₁+fₜ⊙ĥₜ, (14)

ĥₜ=tanh(Uₕ(fₜ⊙hₜ₋₁)+Wₕxₜ+bₕ). (15)

In Equation (13), fₜ iS the forget gate, which is an n-dimensional vector at time step t, and includes the logistic nonlinearity, σ, and accordingly has a value within the range of 0 and 1. The n-dimensional activation vector, hₜ, and the n-dimensional candidate activation unit, ĥₜ, at time step t are represented by Equations (14) and (15). The input vector, xₜ, is an m-dimensional vector, tanh is the nonlinearity expressed here as the hyperbolic tangent function, and ⊙ (in Equations (14) and (15)) represents a point-wise (i.e., Hadamard) multiplication operator. Note that the gate signal (f), activation (h), and candidate activation (ĥ) all have the same number of elements (i.e., are each an n-dimensional vector). The parameters used in GRU 404 are matrices (U_{*}, W_{*}) and biases (b_{*}) in Equations (8), (9) and (11). Accordingly, the total number of parameters (i.e., the number of all the elements in U_{*}, W_{*} and b_{*} and (e.g., N)) can be determined using the following relationship:

N=2×(m×n+n²+n), (16)

where m is the dimension of input vector xₜ and n is the dimension of the cell vector Cₜ, which is a two-fold increase over the number of parameters used by a sRNN unit, but a savings of 2×(m×n+n²+n) parameters compared to LSTM, and a savings of (m×n+n²+n) parameters compared to GRU.

While LSTM RNNs have demonstrated performance in applications involving sequence-to-sequence relationships, a criticism of the conventional LSTM resides in its relatively complex model structure with 3 gating signals and its relatively large number of parameters. The gates essentially replicate the parameters in the cell, and the gates serve as control signals expressed in (2)-(4). Similarly, GRU and MGU have produced results that are comparable to the performance of LSTM RNNs (in at least some dataset demonstrations), however, the gating signals in the latter RNNs (and LSTM RNNs) are replicas of the hidden state in the simple RNN in terms of parametrization. The weights corresponding to these gates are also updated using the backpropagation through time (BTT) stochastic gradient descent (during training) as the RNN seeks to minimize a loss/cost function. Accordingly, each parameter update for each gating signal involves information pertaining to the state of the overall network. In light of this, all information regarding the current input and the previous hidden states are reflected in the latest state variable, resulting in redundancy in the signals driving the gating signals. If instead of using both information about the input and the state of the entire network to derive and/or calculate the gating signals, emphasis is focused instead on the internal state of the network (e.g., the activation function), there is an opportunity to reduce the number of parameters used in the gating signals. As during training the control signal is configured to seek the desired sequence-to-sequence mapping using the training data, the training process uses guidance to minimize the given loss/cost function according to some stopping criterion. This opens possibilities of other forms of the control signal besides those described above in connection with FIG. 4.

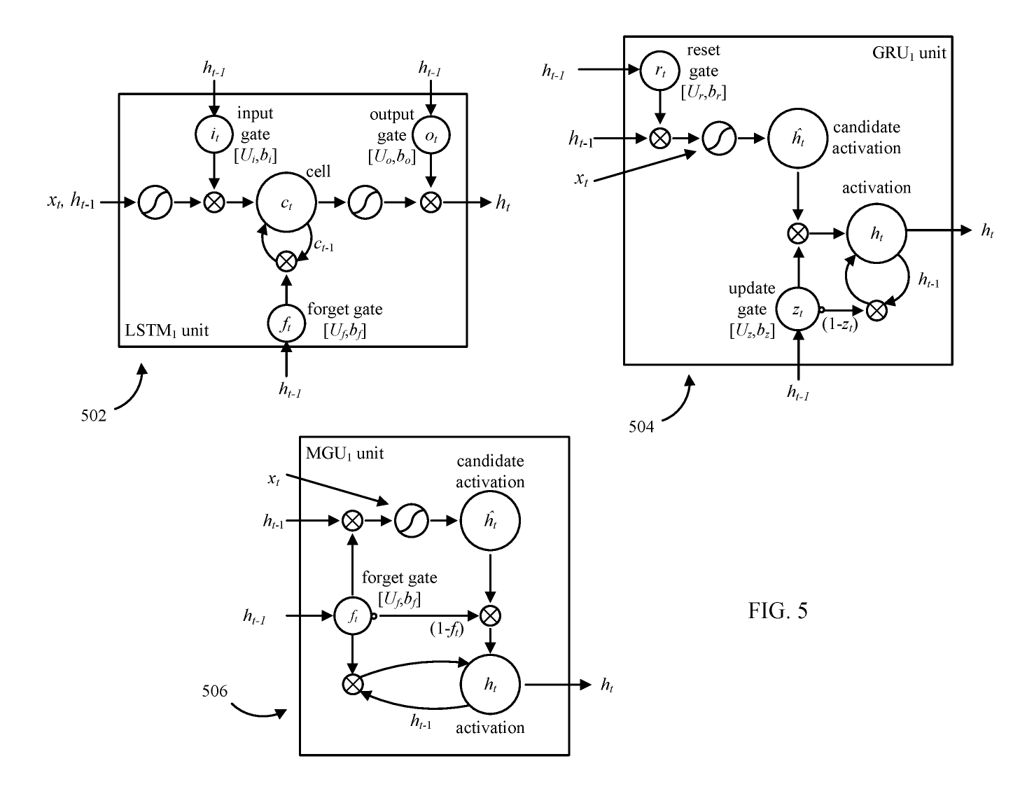

FIG. 5 shows an example of variants of the RNN units shown in FIG. 4 in accordance with some embodiments of the disclosed subject matter in which a hidden unit can be modified by omitting the weighting matrices W_{*} and removing reliance on the input vector Xₜ. For example, an LSTM1 unit 502 is an example implementation of an LSTM unit with reduced gating parameters. In LSTM1 unit 502, the gating signals can be represented as follows:

iₜ=σ(Uᵢhₜ₋₁+bᵢ), (17)

fₜ=σ(U_{f}hₜ₋₁+b_{f}), (18)

Oₜ=σ(U_{O}hₜ₋₁+b_{O}). (19)

As another example, GRU1 unit 504 is an example implementation of a GRU unit with reduced gating parameters. In GRU1 unit 504, the gating can be represented as follows:

zₜ=σ(U_{z}hₜ₋₁+b_{z}), (20)

rₜ=σ(Uᵣhₜ₋₁+bᵣ) (21)

As yet another example, MGU1 unit 506 is an example implementation of a MGU unit with reduced gating parameters. In MGU1 unit 506, the gating signal can be represented as follows:

fₜ=σ(U_{f}hₜ₋₁+b_{f}) (22)

In the three examples shown in FIG. 5, the number of parameters is reduced by 3 mn, 2 mn, and mn parameters, respectively, and for each gating signal one matrix multiplication is eliminated. In the variants shown in FIG. 5, the gating signals are reliant on the unit history and the bias vector.

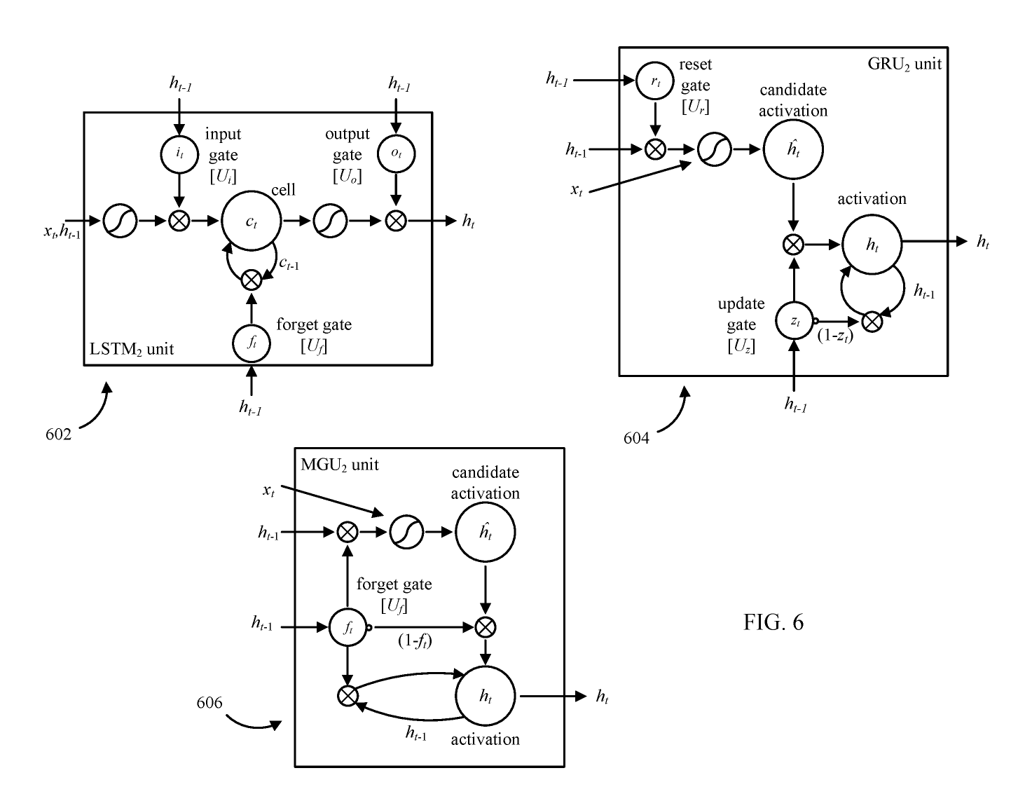

FIG. 6 shows another example of variants of the RNN units shown in FIG. 4 in accordance with some embodiments of the disclosed subject matter in which a hidden unit can be modified by omitting the weighting matrices W_{*} removing reliance on the input vector xₜ, and omitting the bias vectors b_{*}. For example, LSTM2 unit 602 is an example implementation of an LSTM unit with reduced gating parameters. In LSTM2 unit 602, the gating signals can be represented as follows:

iₜ=σ(Uᵢhₜ₋₁) (23)

fₜ=σ(U_{f}hₜ₋₁), (24)

Oₜ=σ(U_{O}hₜ₋₁). (25)

As another example, GRU2 unit 604 is an example implementation of a GRU unit with reduced gating parameters. In GRU2 unit 604, the gating can be represented as follows:

zₜ=σ(U_{z}hₜ₋₁), (26)

rₜ=σ(Uᵣhₜ₋₁) (27)

As yet another example, MGU2 unit 606 is an example implementation of a MGU unit with reduced gating parameters. In MGU2 unit 606, the gating signal can be represented as follows:

fₜ=σ(U_{f}hₜ₋₁). (28)

In the three examples shown in FIG. 6, the number of parameters is reduced by 3 (mn+n), 2 (mn+n), and mn+n parameters, respectively, and for each gating signal one matrix multiplication is eliminated. In the variants shown in FIG. 6, the gating signals are reliant on the unit history, not the input or a bias vector.

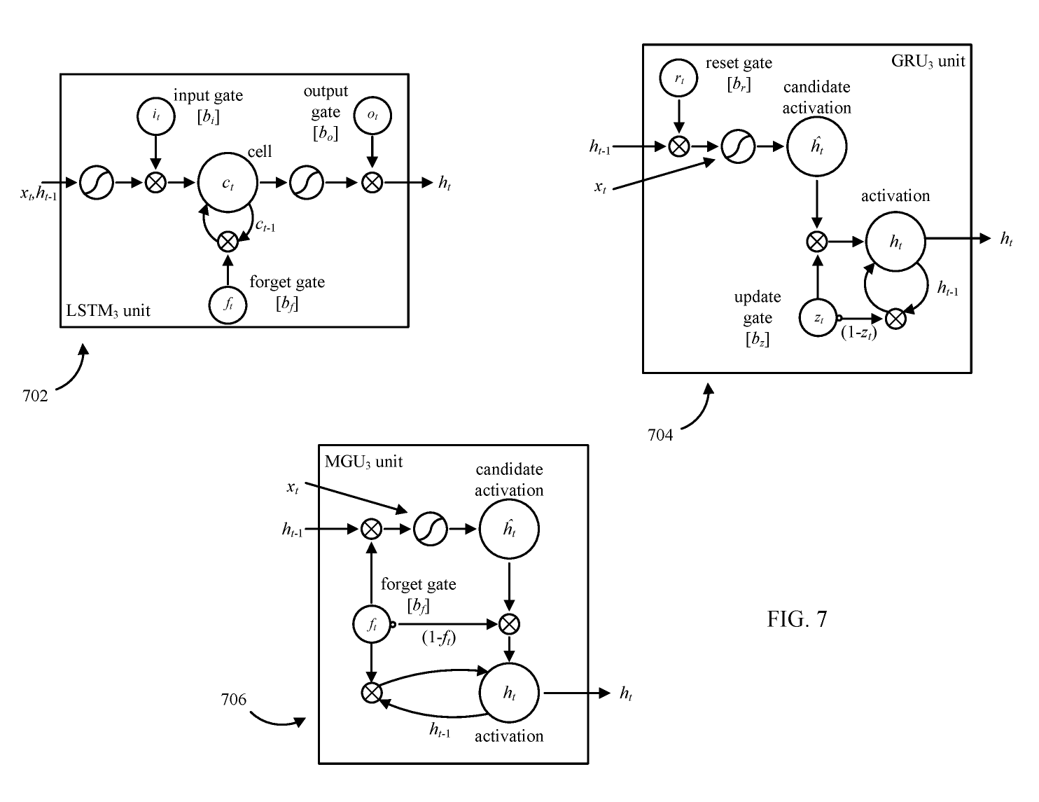

FIG. 7 shows yet another example of variants of the RNN units shown in FIG. 4 in accordance with some embodiments of the disclosed subject matter in which a hidden unit can be modified by omitting the weighting matrices W_{*}and U_{*}, and removing reliance on the input vector xₜ and the previous hidden state hₜ₋₁. For example, LSTM3 unit 702 is an example implementation of an LSTM unit with reduced gating parameters. In LSTM3 unit 702, the gating signals can be represented as follows:

iₜ=σ(bᵢ), (29)

fₜ=σ(b_{f}), (30)

oₜ=σ(bₒ). (31)

As another example, GRU3 unit 704 is an example implementation of a GRU unit with reduced gating parameters. In GRU3 unit 704, the gating can be represented as follows:

zₜ=σ(b_{z}), (32)

rₜ=σ(bᵣ) (33)

As yet another example, MGU3 unit 706 is an example implementation of a MGU unit with reduced gating parameters. In MGU3 unit 706, the gating signal can be represented as follows:

fₜ=σ(b_{f}) (34)

In the three examples shown in FIG. 7, the number of parameters is reduced by 3(mn+n²), 2(mn+n²), and mn+n² parameters, respectively, and for each gating signal two matrix multiplications are eliminated.

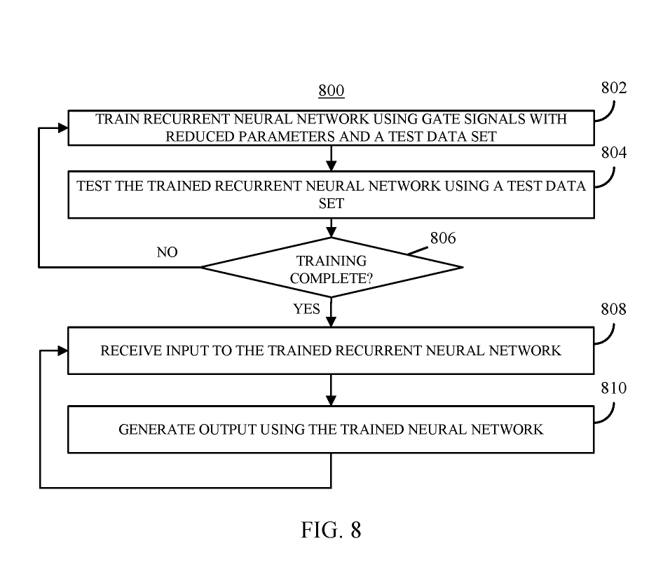

FIG. 8 shows an example of a process 800 for training and inference using gated RNNs with reduced parameter gating signals in accordance with some embodiments of the disclosed subject matter. At 802, process 800 can train an RNN using gate signals with reduced parameters and a test data set. In some embodiments, process 800 can use any suitable technique for training the recurrent neural network, such as known techniques for training a deep neural network.

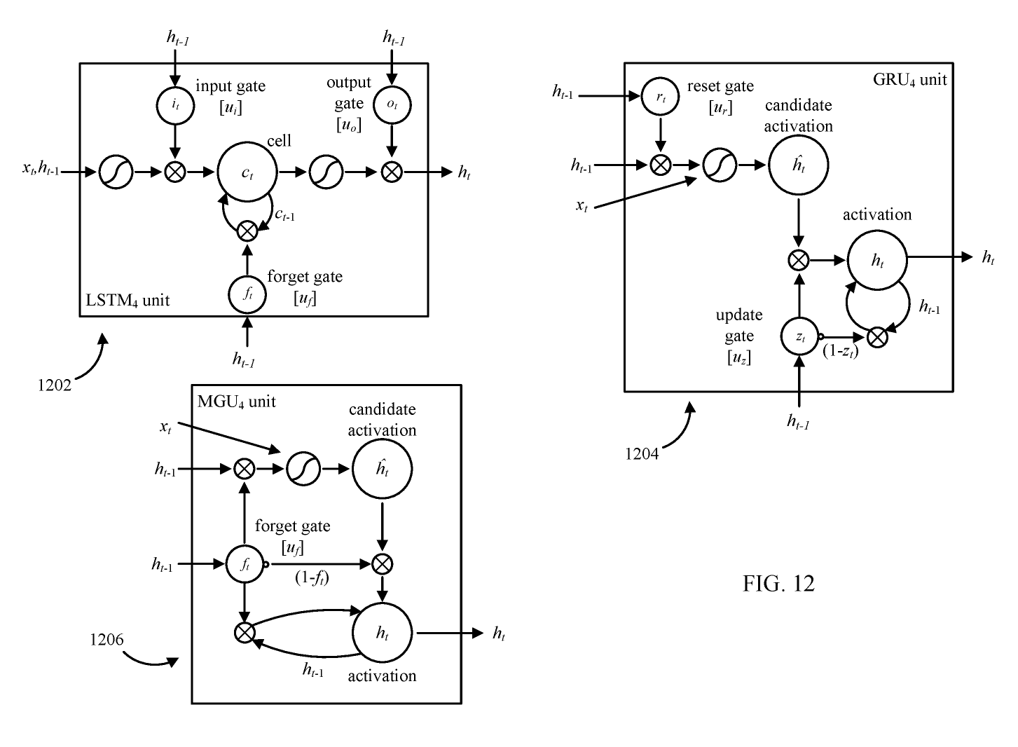

As another example, process 800 can use gating signals according to any of the various RNNs and variants described above in connection with FIGS. 5-7 and/or below in connection with FIGS. 12-18. In some embodiments, the training data set can include any suitable data set with known positive and/or negative examples (for supervised learning approaches) of particular patterns. In a more particular example, the training data set can include known good translations of phrases and/or sentences from a first language to another.

At 804, process 800 can validate and/or test the trained RNN using a validation and/or test data set to determine whether the training phase is complete. In some embodiments, process 800 can use any suitable technique or combination of techniques to test the trained neural network to determine whether the RNN has been sufficiently trained. For example, by determining that the trained RNN correctly translates test phrases, makes fewer than a particular number (or percentage of errors), accurately classifies a particular proportion of the training data set, etc.

At 806, if process 800 determines that training is not complete (“NO” at 806), process 800 can return to 802 and continue to train the RNN. Otherwise, if process 800 determines that training is complete (“YES” at 806), process 800 can move to 808 and begin an inference phase by receiving input provided from a user. For example, as described above in connection with FIG. 3, input can be provided from a computing device in the form of a string of text (and/or its coded representation) to be translated. This training process can use input in the form of a sequence of one or more samples. Note that training may be performed in a batch mode or online, sample by sample, or sequence by sequence. For example, a training phase can be performed prior to deployment followed by a testing/inference phase, and an additional training phase (or phases) can be performed during deployment followed by additional testing/inference. This may result in the parameters being further updated after an initial deployment.

At 810, process 800 can generate an output using the trained recurrent neural network to analyze the input. For example, process 800 can provide the received input to the trained recurrent neural network, convert the input to an input vector (Xₜ), use the input vector to calculate an output vector (e.g., hₜ, and/or a subsequent linear and/or softmax layer), convert the output(s) to a semantically meaningful output, and provide the semantically meaningful output back to the computing device that sent the input.

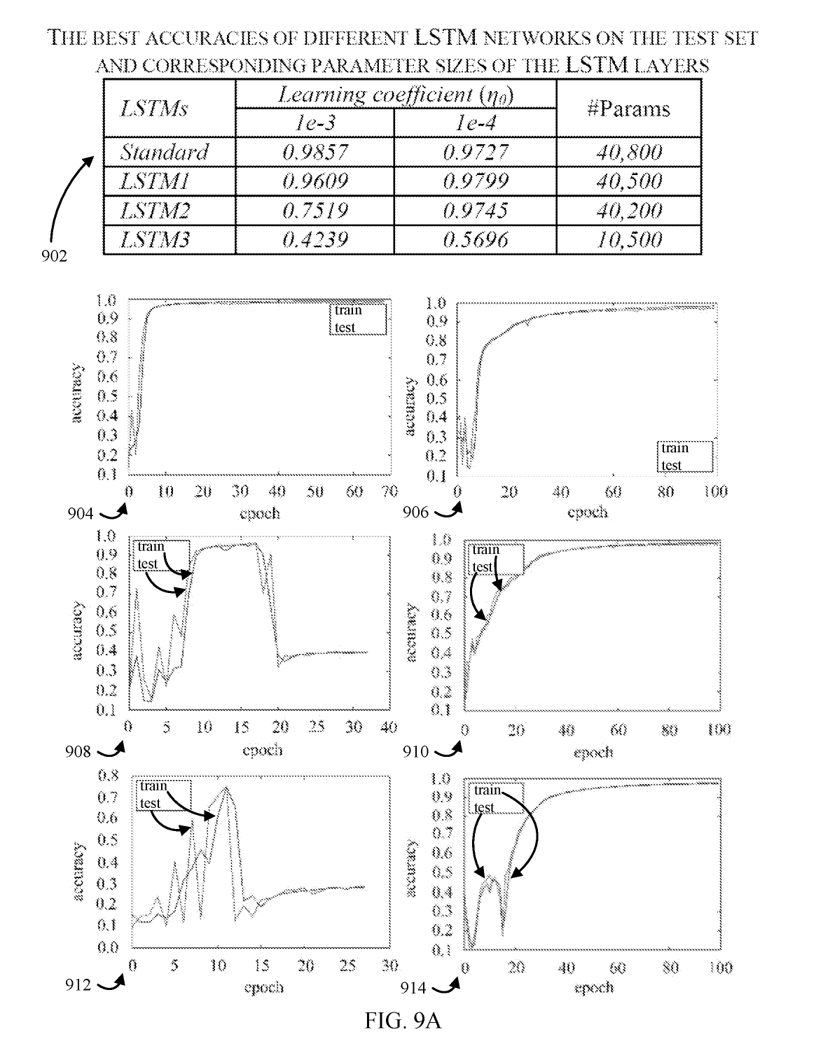

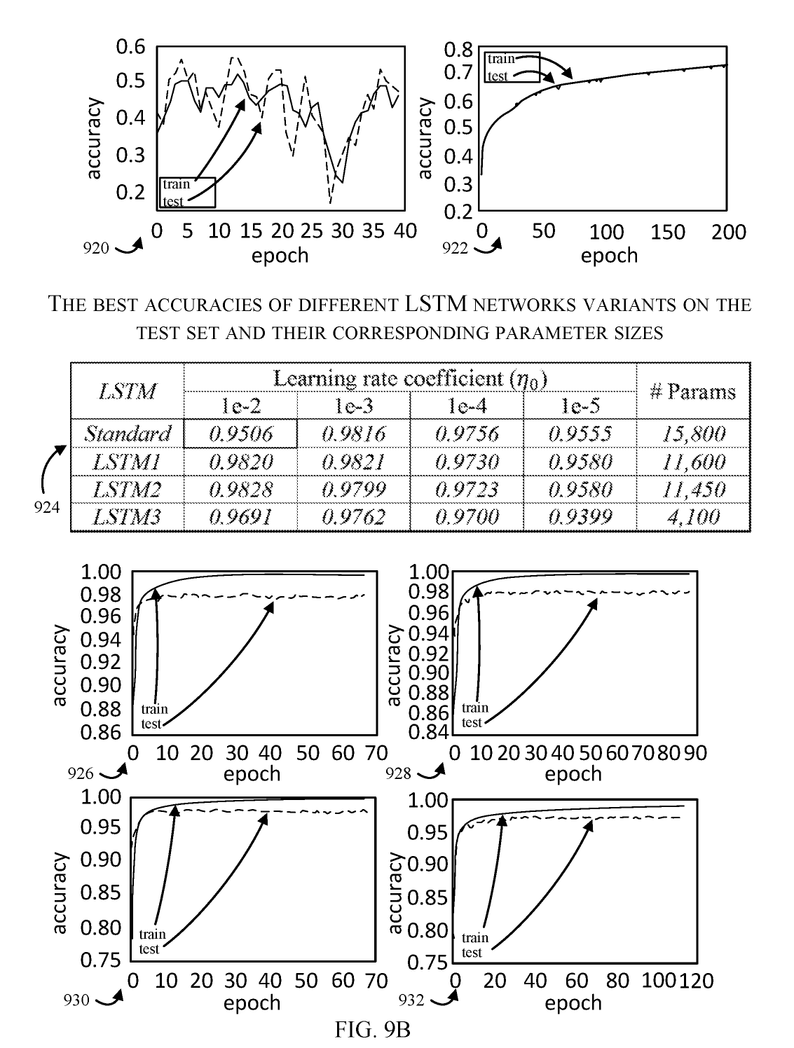

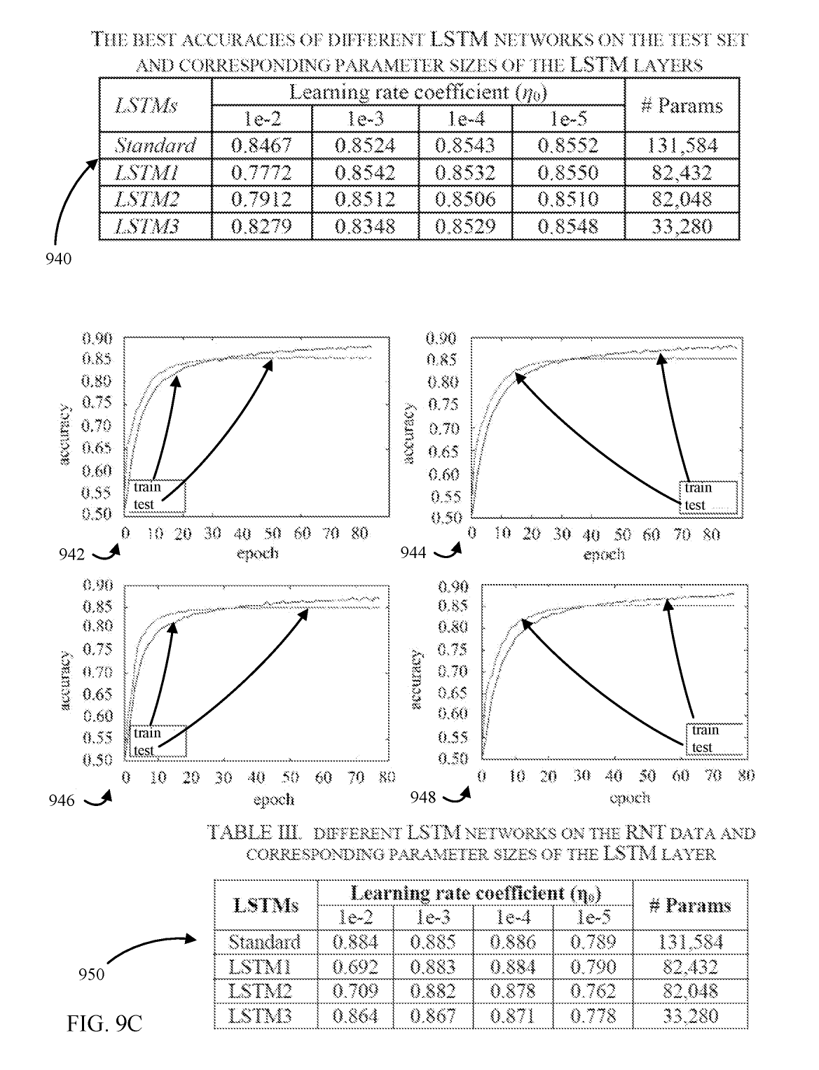

FIGS. 9A to 9C show examples of results generated by RNNs using LSTM variants in accordance with some embodiments of the disclosed subject matter. The effectiveness of the three variants described herein were evaluated using two public datasets, MNIST and IMDB. The results described below in connection with FIGS. 9A to 9C demonstrate the comparative performance of a “conventional” LSTM RNN and the variants described herein.

The MNIST dataset included a set of 60,000 training images and a set of 10,000 testing images of handwritten examples of the digits (0-9) each represented as a 28×28 pixel image. The training set includes labels indicating which class the image belongs to (i.e., which number is represented in the image). The image data were pre-processed to have zero mean and unit variance, and two different techniques for formatting the data for input to an LSTM-based RNN were tested. The first technique was to generate a one-dimensional vector by scanning pixels row by row, from the top left corner of the image to the bottom right corner. This results in a long sequence input vector of length 784. The second technique treats each row of an image as a vector input, resulting in a much shorter input sequence of length 28. The two types of data organization are referred to herein as pixel-wise sequence inputs, and row-wise sequence inputs, respectively. Note that the pixel-wise sequence is more time consuming in training (due at least in part, for example, to the much longer sequence input). For the pixel-wise sequencing input, 100 hidden units and 100 training epochs were used, while 50 hidden units and 200 training epochs were used for the row-wise sequencing input. Other network settings were kept the same throughout, including a batch size set to 32, RMSprop optimizer, cross-entropy loss, dynamic learning rate (η) and early stopping strategies. More particularly, to speed up training, the learning rate η was set to be an exponential function of training loss. Specifically, η=η₀×exp (C), where η₀ is a constant coefficient, and C is the training loss. For the pixelwise sequence, two learning rate coefficients (η₀=1e⁻³ and η₀=1e⁻⁴) were considered as it takes relatively long time to train, while for the row-wise sequence, four learning rate coefficients (1e⁻², 1e⁻³, 1e⁻, and 1e⁻⁵) were considered.

In general, the dynamic learning rate is directly related to the training performance. At the initial stage, the training loss is typically large, resulting in a large learning rate (η), which in turn increases the stepping of the gradient further from the present parameter location. The learning rate decreases as the loss functions decreases towards a lower loss level, and eventually towards an acceptable minima in the parameter space. The early stopping criterion caused the training process to be terminated if there was no improvement on the test data over a predetermined number of consecutive epochs. More particularly, an early stopping criterion of 25 epochs was used to generate the results described herein in connection with FIGS. 9A and 9B.

As shown in FIG. 9A, table 902 summarizes the accuracies on the test dataset for the pixel-wise sequence. At η₀=1e⁻³, the conventional LSTM produced the highest accuracy, while at η₀=1e⁻⁴, both LSTM1 and LSTM2 (described above in connection with FIGS. 5 and 6, respectively) achieved accuracies slightly higher than the accuracy achieved by the conventional LSTM. LSTM3 (described above in connection with FIG. 7) achieved the least accuracy in both cases. As shown in FIG. 9A, training curves 904-914 illustrate differences in learning accuracy based on the selected learning dynamic learning rate nₒ and the different responses of the LSTMs. In 904 and 906, the conventional LSTM performed relatively well in both cases (η₀=1e⁻³ and η₀=1e⁻⁴, respectively), while LSTM1 (908 showing results for η₀=1e⁻³) and LSTM2 (912 showing results for η₀=1e⁻³) performed similarly poorly with η₀=1e⁻³. More particularly, both suffered fluctuations at beginning and lowered accuracies at the end. However, decreasing η₀=1e⁻⁴ generated more accurate results for both LSTM1 (910 showing results for η₀=1e⁻⁴) and LSTM2 (914 showing results for η₀=1e⁻⁴). As shown in FIG. 9B, results 920 and 922 were generated using LSTM3 using η₀=1e⁻⁴ and η₀=1e⁻⁵, respectively. Results for neither η₀=1e⁻³ nor η₀=1e⁻⁴ were positive due to fluctuations. However, as shown in 924 when 200 training epochs were executed, choosing η₀=1e⁻⁵ provided a steadily increasing accuracy with a highest test accuracy of 0.7404, which underperformed the other LSTMs variants. While high accuracy was not achieved in 200 epochs, a relatively high accuracy may be achievable with longer training times.

The fluctuation phenomenon observed in 908, 912 and 920 is a typical issue caused by a large learning rate, and may be due to numerical instability where the (stochastic) gradient can no longer be approximated. This issue can generally be resolved by decreasing the learning coefficient (however, at the cost of slowing down training). From the results, while the conventional LSTM appears more resistant to fluctuations in modeling long-sequence data, it requires more parameters. The results shown in 902-922 show that the three LSTM variants were capable of handling long-range dependency sequences comparably to the conventional LSTM, while using fewer parameters.

As shown in FIG. 9B, table 924 and graphs 926-932 (at η₀=1e⁻³) show results for the row-wise sequence form. Compared to the pixel-wise sequence of length 784, the row-wise sequence form of length 28 was much easier (and faster) to train. As shown in table 924, all the LSTM variants achieved high accuracies at four different values of η₀. The conventional LSTM (926), LSTM1 (928) and LSTM2 (930) performed similarly, where they all slightly outperformed the LSTM3 (932). No fluctuation issues were encountered in any of the cases, and results were generated using 50 hidden units.

Among the four values of η₀, η₀=1e⁻³ achieved the best results for all the LSTMs except LSTM2 that performed the best at η₀=1e⁻² (see table 924). As shown in 926-932, all the LSTM variants exhibited similar training pattern profiles at η₀=1e⁻³, which demonstrates the efficacy of the three LSTM variants in comparison to the conventional LSTM.

Note that, from the results of the pixel-wise (long) and row-wise (short) sequence data, the three LSTM variants, especially LSTM3, performed closely similar to the conventional LSTM in handling the short sequence data, while using fewer parameters.

As shown in FIG. 9C, a dataset including 50,000 movie reviews from IMDB, which are labelled into two classes according to (the reviews) sentiment (positive or negative), were used to generate the results shown in table 940. Both the training set and test set contained 25,000 reviews. The reviews are encoded as a sequence of word indices based on the overall frequency in the dataset. The maximum sequence length was set to 80 among the top 20,000 most common words (longer sequences were truncated while shorter ones were zero-padded at the end). Referring to an example in the Library Keras, an embedding layer with an output dimension of 128 was added as an input to the LSTM layer that contained 128 hidden units. The dropout technique was implemented to randomly zero 20% of signals in the embedding layer and 20% of rows in the weight matrices (i.e., the U and W matrices) in the LSTM layer. The model was trained for 100 epochs. Other settings were the same as those described above in connection with the MNIST data. Training LSTMs for the two datasets were implemented using the Keras package in conjunction with a revised layer and the Theano library (a sample implementation code and results are available at: https[colon]//github[dot]com/jingweimo/Modified-LSTM).

For this dataset, the input sequence from the embedding layer to the LSTM layer is of the length 128. Testing results for various learning coefficients are shown in table 940. The conventional LSTM and the three variants show similar accuracies, except that LSTM1 and LSTM2 show slightly lower performance at η₀=1e⁻². Similar to the row-wise MNIST sequence case study, no large fluctuations are shown for any of the four values of η₀. Graphs 942-948 (at η₀=1e⁻⁵) show results for the IMDB dataset.

As shown in FIG. 9C, table 950 represents results for a dataset that includes 11,228 newswires from Reuters, labelled over 46 topics or classes. As in the IMDB dataset described above, each wire is encoded as a sequence of word indexes. The top 1,000 most frequent words were considered in loading the dataset. Note that this dataset is extremely unbalanced, some topics have thousands of newswires while the majority have only dozens of newswires. To address this issue, and to simplify the training, only the top five topics were chosen for illustration, which contained 8,157 newswires. The reduced dataset were then partitioned into training and test sets by the ratio of 3:1. Other settings remained the same as those in the IMDB data. The results shown in table 950 were generated using a network with the same architecture of embedding and LSTM layers as described above in connection with the IMDB dataset. As shown in tables 940 and 950, the two datasets have the same parameter sizes of the LSTM layer. As shown in table 950, all the LSTM variants exhibit similar training patterns to one another (and to the LSTM variants using in connection with the IMDB dataset). The conventional LSTM and the three variants provide similar test accuracies for all the η₀ values except η₀=1e⁻², where LSTM1 and LSTM2 produce similar but lower accuracies in comparison to the accuracies shown in table 940. The decreased accuracies at η₀=1e⁻⁵ may be due to the decreased learning rate and would likely improve with more training epochs.

As can be appreciated from tables 902, 924, 940, and 950, using the three LSTM variants described above can facilitate a reduction in the number of parameters involved, which can reduce the computation expense (and in some cases, time expenses incurred by I/O limitations when the model is memory bound) of executing a classification model. This has been confirmed from the experiments and as summarized in the three tables above. The LSTM1 and LSTM2 show small difference in the number of parameters and both contain the hidden unit signal in their gates. The LSTM3 has dramatically reduced parameters size since it only uses the bias, an indirectly contained delayed version of the hidden unit signal via the gradient descent update equations. This may explain the relative lagging performance of the LSTM3 variant, especially in long sequences. Note that the actual reduction of parameters is dependent on the structure (i.e., dimension) of input sequences and the number of hidden units in the LSTM layer.

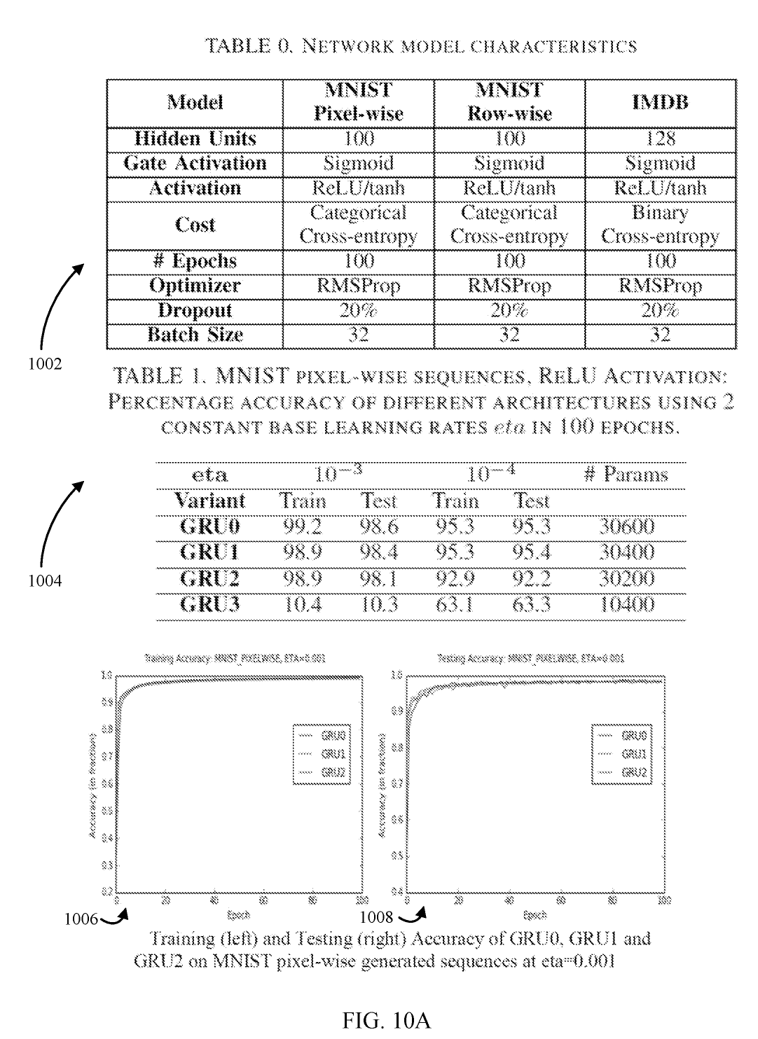

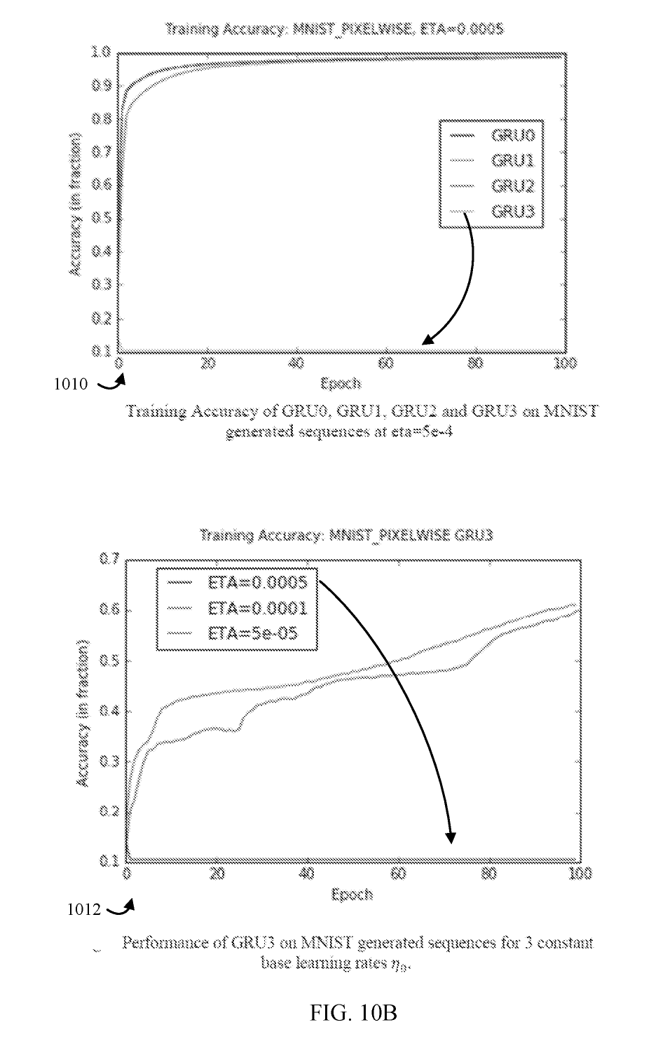

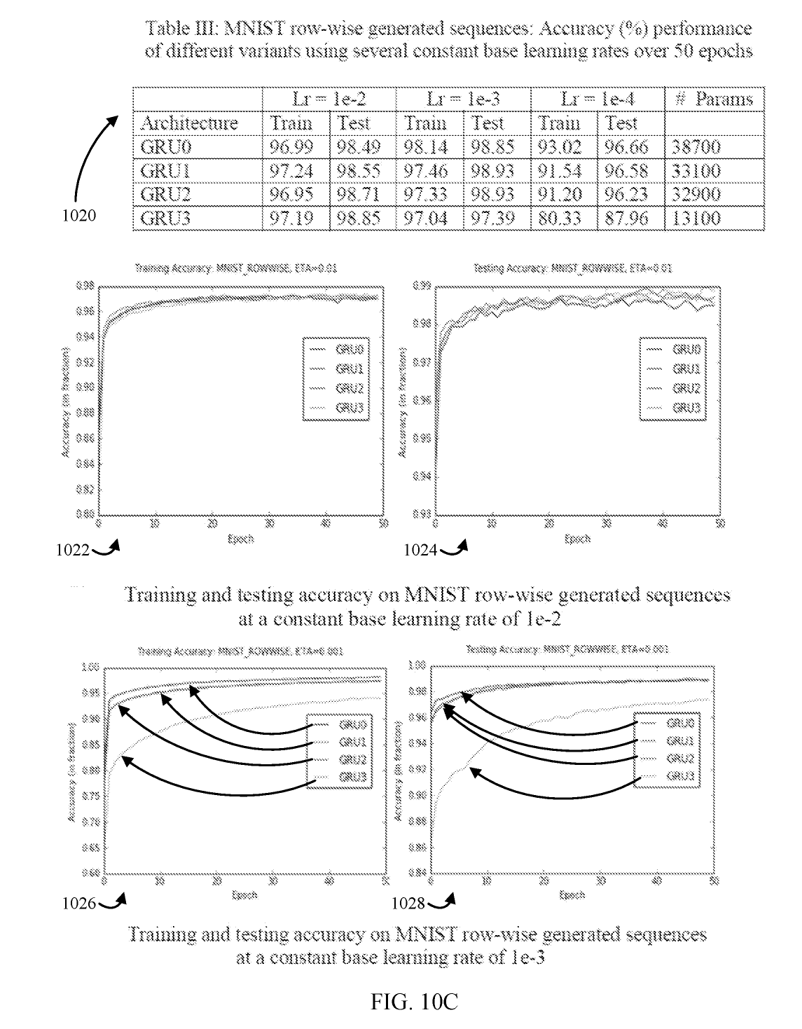

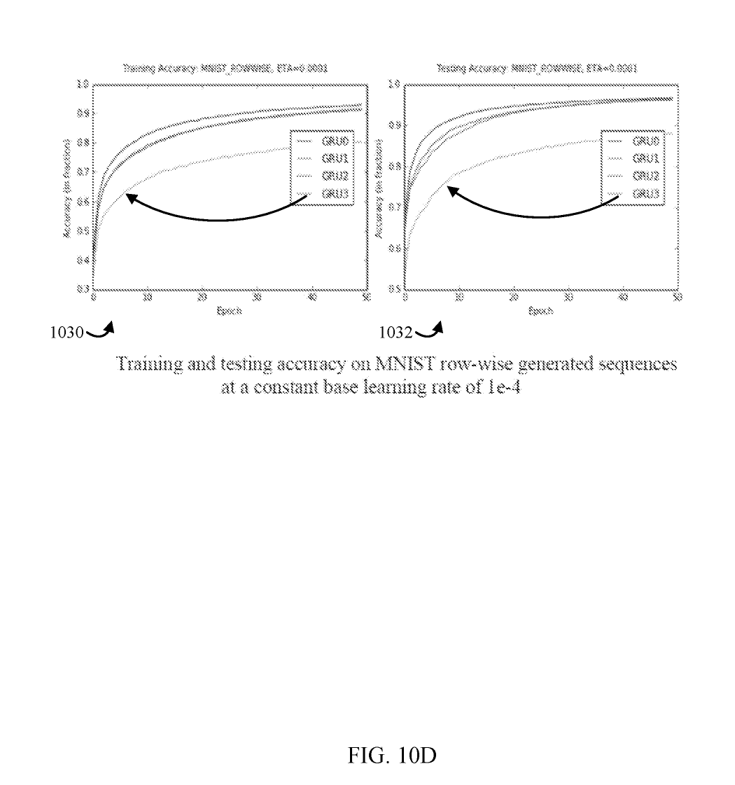

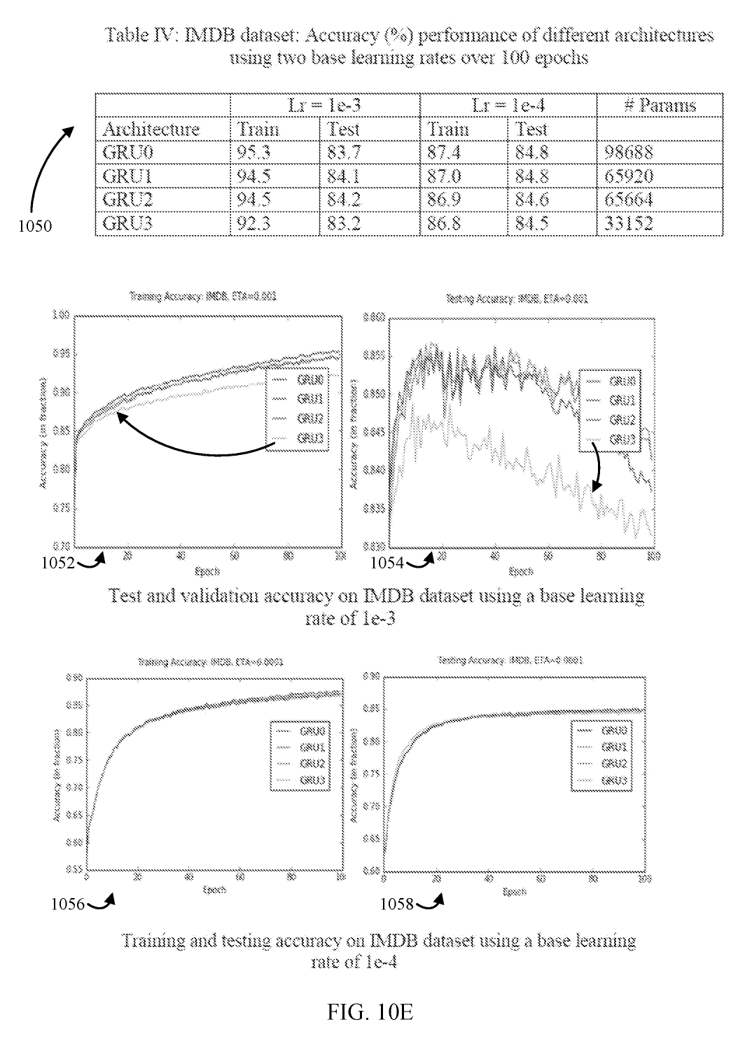

FIGS. 10A to 10E show examples of results generated by RNNs using GRU variants in accordance with some embodiments of the disclosed subject matter. The results for the three variants are compared to the performance of the “conventional” GRU RNN on sequences generated from the MNIST dataset, and also the IMDB dataset. Note that the conventional GRU is referred to as GRU0.

The architecture of the GRU RNN includes a single layer of one of the variants of GRU units driven by the input sequence and the activation function g set as ReLU or hyperbolic tangent (tanh). For the MNIST dataset, the pixel-wise and the row-wise sequences were used. The networks were generated in Python using the Keras library with Theano as a backend library. As Keras has a GRU layer class, this class was modified to create classes for GRU1, GRU2, and GRU3. Each network was trained and tested using the tanh activation function, and separately using the ReLU activation function. The layer of GRU units is followed by a softmax layer in the case of the MNIST dataset and a traditional logistic activation layer in the case of the IMDB dataset to predict the output category. The Root Mean Square Propagation (RMSprop) is used as an optimizer that is known to adapt the learning rate for each of the parameters. To speed up training, the learning rate was exponentially decayed with the cost in each epoch expressed as:

η(n)=η×e^{cost(n-1}), (35)

where η represents a base constant learning rate, n is the current epoch number, cost(n−1) is the cost computed in the previous epoch, and η(n) is the current epoch learning rate. The networks were trained for a maximum of 100 epochs. Some details of the various networks are shown in table 1002.

As shown in table 1004, at η₀=1e⁻³, the conventional LSTM produced the highest accuracy, while at η₀=1e⁻⁴, both LSTM1 and LSTM2 achieved accuracies slightly higher than that by the conventional LSTM. LSTM3 performed the worst in both cases. Examining the training curves (not shown) showed that the failure of LSTM3 was caused by severe training fluctuation due to relatively large learning rates, which undermines the validity of gradient approximation leading to numerical instability of training. That is, although LSTM3 has the lowest number of parameters, it tends to suffer from training fluctuations, which can be ameliorated with lower learning rates and more epochs to improve the test accuracy. Decreasing η₀ to 1e⁻⁵ and training 200 epochs confirmed this, as it yielded a test accuracy of 0.740. Further improved accuracy would likely be attained if longer training time was allowed.

As shown in FIG. 10A, graphs 1006 and 1008 show accuracy of training on the MNIST dataset for various GRU variants at η=0.001. As shown in FIG. 10B, graph 1010 shows accuracy of training on the MNIST dataset for various GRU variants with η=5e⁻⁴, and graph 1012 shows accuracy of training on the MNIST dataset for GRU3 over various values of η.

As shown in FIGS. 10C and 10D, table 1020 and graphs 1022-1032 show that each of the GRU variants (GRU0, GRU1, GRU2, and GRU3) appear to exhibit comparable accuracy performance over three constant base learning rates. However, GRU3 exhibits lower performance at the base learning rate of 1e⁻⁴ and is lagging after 50 epochs. However, as shown in FIG. 10D, it appears that the profile has not yet leveled off for GRU3, and likely would continue increasing with more training epochs to a comparable level with the other variants. Note that GRU3 can achieve comparable performance with roughly one third of the number of (adaptively computed) parameters, which can lead to relatively large savings in computational expense (and/or I/O actions), which may be more favorable in some applications and/or depending on available resources.

FIG. 10E shows examples, in table 1050 and graphs 1052-1058, of results generated by training all 4 GRU variants using the two constant base learning rates of 1e⁻³ and 1e⁻over 100 epochs on the IMDB dataset. Table 1050 summarizes the results of accuracy performance which show comparable performance among GRU0, GRU1, GRU2, and GRU3, and lists the number of parameters in each. In the training, 128-dimensional GRU RNN variants were used, a batch size of 32 was used. As shown in graph 1054, using the constant base learning rate of 1e⁻³, performance fluctuates visibly on the test data, whereas performance is uniformly progressing over profile-curves as shown in graph 1058.

It is clear from FIG. 10E that all three GRU variants perform comparably to the conventional GRU RNN while using significantly fewer parameters. The learning pace of GRU3 was also similar to those of the other variants at the constant base learning rate of 1e⁻⁴.

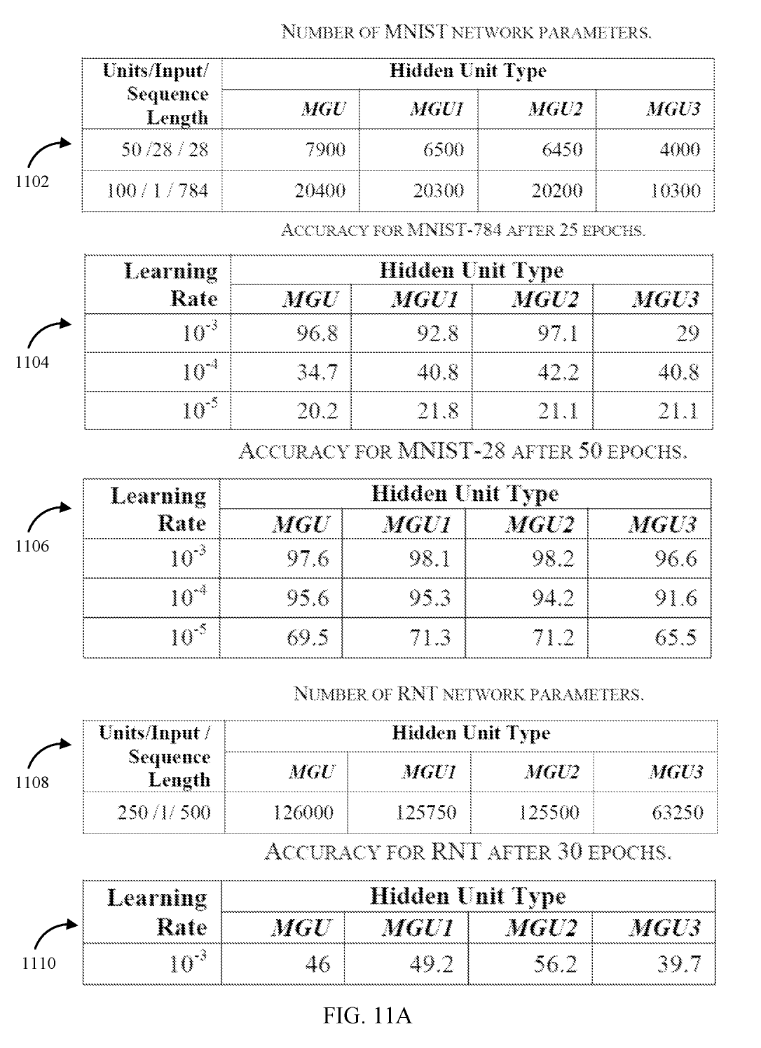

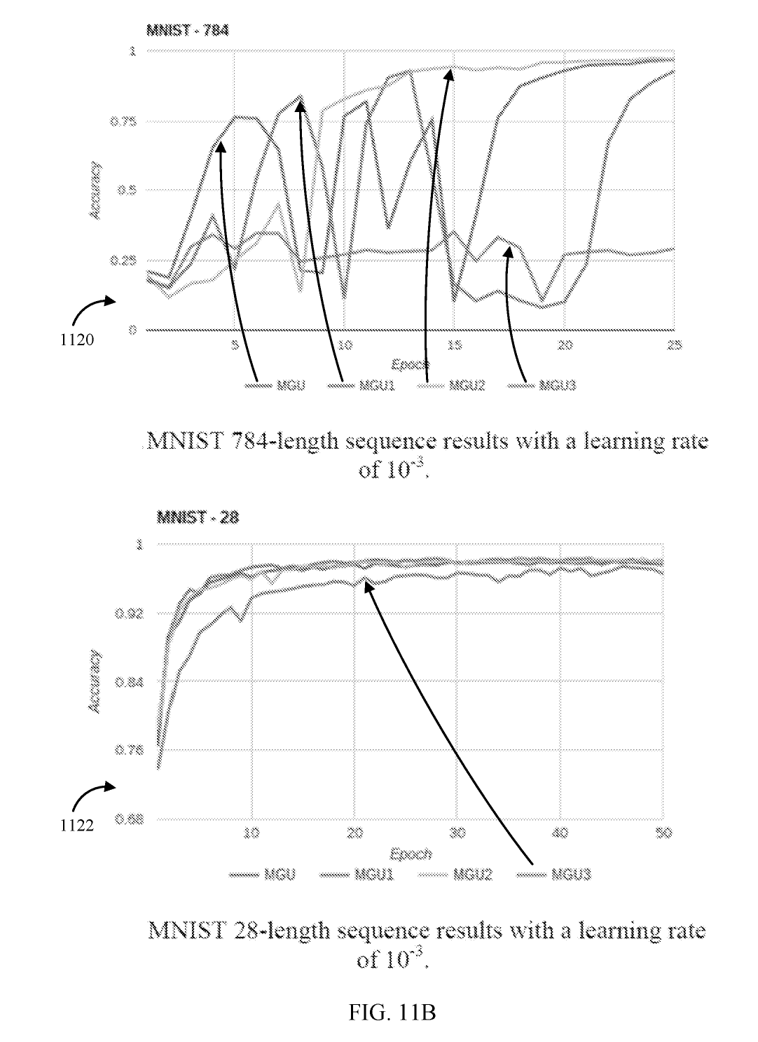

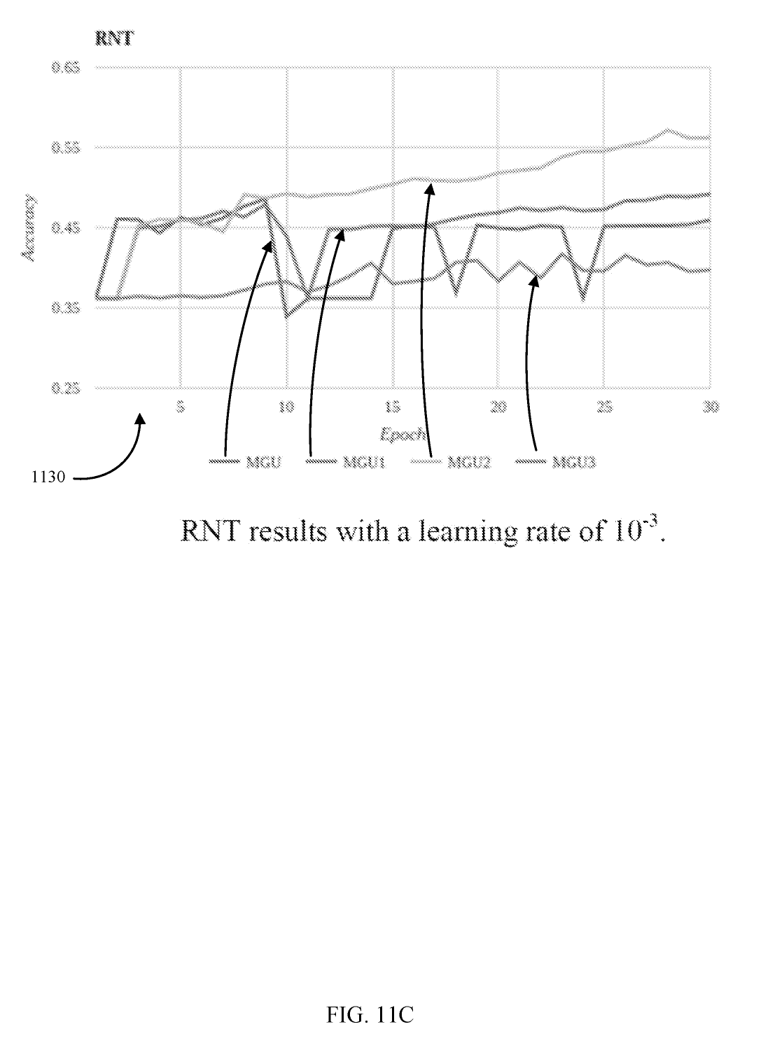

FIGS. 11A to 11C show examples of results generated by RNNs using MGU variants in accordance with some embodiments of the disclosed subject matter. The “conventional” MGU and three variants were tested using the MNIST dataset and RNT dataset, and were created in Python using the Keras deep learning library and Theano. As Keras has a GRU layer class, this class was modified to create classes for the conventional MGU, MGU1, MGU2, and MGU3 variations. All of these classes used the hyperbolic tangent function for the candidate activation, and the logistic sigmoid function for the gate activation.

The MNIST networks used a batch size of 100 and the RMSProp optimizer. A single layer of hidden units was used with 100 units for the 784-length sequences and 50 units for the 28-length sequences. The output layer was a fully connected layer of 10 units in both cases. As shown in FIG. 11A, table 1102 summarizes the number of (adaptive) parameters used in the MGU, MGU1, MGU2, and MGU3 to generate the results described herein. The 28-length sequences were run for 50 epochs, while the 784-length sequences were run for 25 epochs to decrease training time for the longer sequences. Both networks were trained on multiple learning rates for the RMSProp optimizer, η=1e⁻³, 1e⁻⁴, and 1e⁻⁴.

As shown in table 1104, the best performance on the 784-length MNIST data resulted from a learning rate of 1e⁻³. Initial performance with that learning rate was inconsistent with significant spikes in the accuracies until the later epochs, as shown in graph 1120 in FIG. 11B. For most of the epochs, MGU2 had the best accuracy, and it achieved slightly better accuracy than MGU after only 25 epochs (as shown in graph 1120). MGU3 performed consistently poorly with a learning rate of 1e⁻³. For a low epoch of 25 and with a learning rate of 1e⁻⁴ or 1e⁻⁵, MGU3 achieved accuracies similar to the other models, as shown in table 1104.

As shown in table 1106, the performance on the 28-length sequence MNIST data was relatively high after 50 epochs. Graph 1122 in FIG. 11B shows that the accuracy is above 90% after just several epochs for all models (although MGU3 consistently performs somewhat worse). As shown in table 1106, the highest performance resulted from a learning rate of 1e⁻³, although a rate of 1e⁻³ was only slightly worse. Overall, using the MNIST dataset, and the selected hyper-parameters, MGU1 and MGU2 produce comparably accurate results to the conventional MGU, while MGU3 require different hyper-parameter settings and/or more epochs. However, note that for two of the learning rates tested (including the best performing learning rate), MGU1 and MGU2 outperformed MGU by at least 0.5%, and MGU3 performed relatively well even though it only includes the bias term in the gate equation.

The RNT dataset was evaluated using a sequence length of 500, with 250 units in one hidden layer, and a batch size of 64. The output layer included 46 fully connected units. Other combinations of sequence length and hidden units were evaluated, and the best results were with a ratio of about 2-to-1. Instead of RMSProp, the Adam optimizer was used in evaluating the RNT dataset. The learning rate was the default 1e⁻³, and the variants were trained across 30 epochs, which was long enough to show a plateau in the resulting accuracy while still being relatively short. As shown in FIG. 11A, table 1108 summarizes the (adaptive) parameters used in the model variants when using 250 units with sequence dimensions of 500.

As shown in table 1110 and in graph 1130, MGU2 performed the best of the variants on the RNT database, improving upon the accuracy of MGU by 22% (as shown in table 1110). MGU2 also featured a more consistent accuracy across epochs, as shown in graph 1130 in FIG. 11C. Note that the average per-epoch training time for each variant decreases with fewer parameters. For example, MGU2 can be trained more quickly than MGU, while also providing comparable or superior results.

FIG. 12 shows still another example of variants of the RNN units shown in FIG. 4 in accordance with some embodiments of the disclosed subject matter in which a hidden unit can be modified using point-wise multiplication with a vector and omitting the bias vectors b_{*}. In some embodiments, parameters can be further reduced by replacing multiplications of a matrix (e.g., n×n matrix U_{*}) that are used in conventional RNN units (e.g., the RNN units shown described above in connection with FIG. 4) by point-wise multiplications with an n-dimensional vector. For example, a hidden unit (e.g., hₜ₋₁) can be multiplied by a (column) vector u_{*} of the same dimension as the hidden unit (e.g., an n-dimensional vector) reduced from a matrix U_{*}. In a more particular example, as shown in FIG. 12, variants of the control signals for the various RNNs can include using the previous hidden state but with point-wise multiplication, omitting the weighting matrices (e.g., W_{*}), removing reliance on the input vector Xₜ, and omitting the bias vectors b_{*}. As described above, point-wise multiplication of two matrices is sometimes referred to as Hadamard multiplication, and is represented herein using the symbol ⊙. For example, LSTM4 unit 1202 is an example implementation of an LSTM unit with reduced gating parameters. In LSTM4 unit 1202, the gating signals can be represented as follows:

iₜ=σ(uᵢ⊙hₜ₋₁) (36)

fₜ₌σ(u_{f}⊙hₜ₋₁) (37)

Oₜ=σ(u_{O}⊙hₜ₋₁) (38)

As another example, GRU4 unit 1204 is an example implementation of a GRU unit with reduced gating parameters. In GRU4 unit 1204, the gating can be represented as follows:

zₜ=σ(u_{z}⊙hₜ₋₁), (39)

rₜ=σ(uᵣ⊙hₜ₋₁). (40)

As yet another example, MGU4 unit 1206 is an example implementation of an MGU unit with reduced gating parameters. In MGU4 unit 1206, the gating signal can be represented as follows:

fₜ=σ(uᵢ⊙hₜ₋₁). (41)

In the three examples shown in FIG. 12, the number of parameters is reduced by 3×(nm+n²), 2×(nm+n²) and nm+n² parameters, respectively, and for each gating signal two matrix multiplications are eliminated. Note that, in the variants described in connection with FIG. 12, the gating signals are reliant on the unit history, not an input (e.g., xₜ) or a bias vector (e.g., b_{*}).

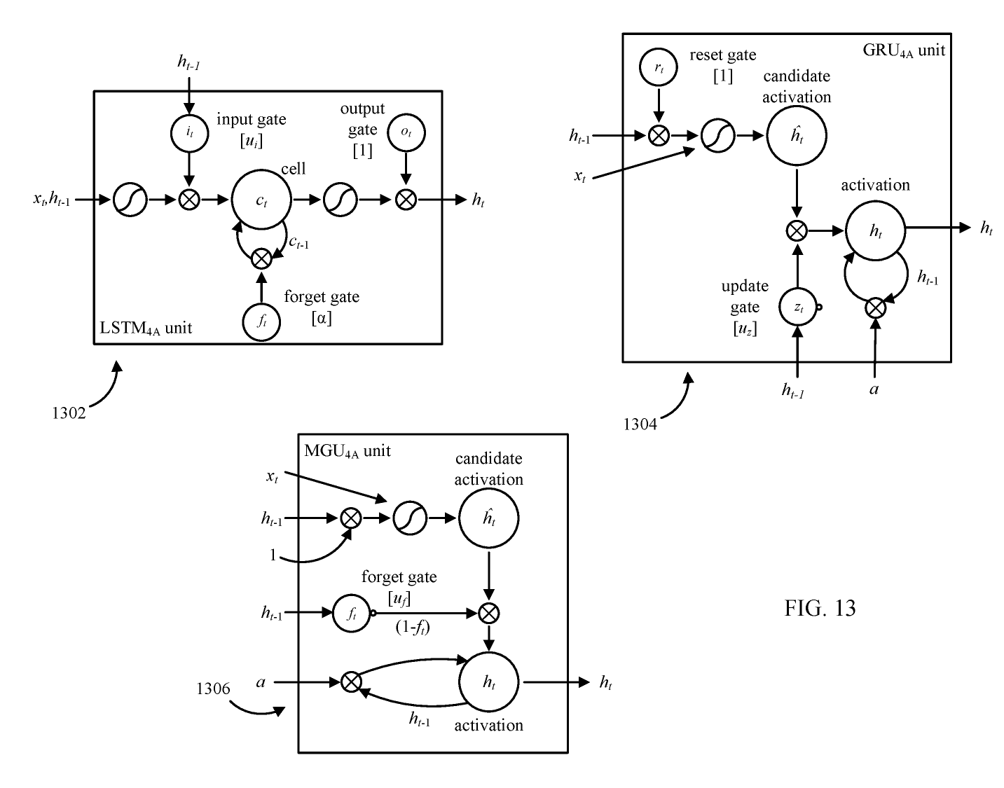

FIG. 13 shows a further example of variants of the RNN units shown in FIG. 4 in accordance with some embodiments of the disclosed subject matter in which a hidden unit can be modified using point-wise multiplication with a vector, omitting the bias vectors b_{*}, and using scalars as gating signals. As shown in FIG. 13, In some embodiments, the control signals for the various RNNs can include calculating what is sometimes referred to as the input (or alternatively, the update) gate using the hidden state with point-wise multiplication, omitting the weighting matrices W_{*}, removing reliance on the input vector xₜ, omitting the bias vectors b_{*}, and/or replacing one or more gating signals with scalars. For example, LSTM4A unit 1302 is an example of an LSTM unit with reduced gating parameters. In LSTM4A unit 132, the gating signals can be represented as follows:

iₜ=σ(uᵢ⊙hₜ₋₁) (42)

fₜ=α,0≤|α|≤1 (43)

Oₜ=1 (44)

In some embodiments, parameter a can be a constant, typically, between 0.5 and 0.96, which can stabilize the (gated) RNN in some cases. Note that setting a gate signal to 1 is equivalent to eliminating the gate signal as the gate signal is multiplied with other signals. For example, in LSTM4A unit 1302 rather than setting the output gate signal to 1, the output gate can be eliminated without affecting the value of the output hₜ. Accordingly, when implementing a RNN in accordance with some embodiments of the described subject matter, gates with gating signals set to 1 can be omitted. However, this may not be practical in some embodiments (e.g., when using a library with RNN units implemented with the conventional gates), and in such embodiments, the gating signal can be modified to be equal to 1. For example, an LSTM unit can be included in a library (e.g., the Keras Library) such that it can be implemented without manually implementing all of the features of the unit. However, in such an example it may impractical (or impossible) to modify the model included in the library to omit a gating signal entirely. In such an example, the gating signal can be set to 1 rather than omitting the gate entirely.

As another example, GRU4A unit 1304 is an example implementation of a GRU unit with reduced gating parameters. In GRU4A unit 1304, the gating signals can be represented or assigned as follows:

zₜ=σ(u_{z}⊙hₜ₋₁) (45)

rₜ=1; and (1−zₜ)→α, 0≤|α|≤1 (46)

As yet another example, MGU4A unit 1306 is an example implementation of an MGU unit with reduced gating parameters. In MGU4A unit 1306, the gating signal can be assigned as follows:

fₜ=σ(u_{f}⊙hₜ₋₁);(1−fₜ)→60 , 0≤|α|≤1 (47)

while now fₜ can be set to 1 in association with the output/reset gate. Note that while MGU4A unit 1306 is described as having a forget gate, but the forget gate signal in MGU4A corresponds to the input gate signal in LSTM4A unit 1302, rather than the forget gate signal from the LSTM unit. Accordingly, the forget gate in MGU4A unit 1306 can be alternatively described as an input gate.

In the three examples shown in FIG. 13, the number of parameters is reduced for all 3 cases to now become n parameters plus one hyper-parameter to be set as a constant (α). In the variants described in connection with FIG. 13, the gating signals are reliant on the unit history, not an input (e.g., xₜ) or a bias vector (e.g., b_{*}).

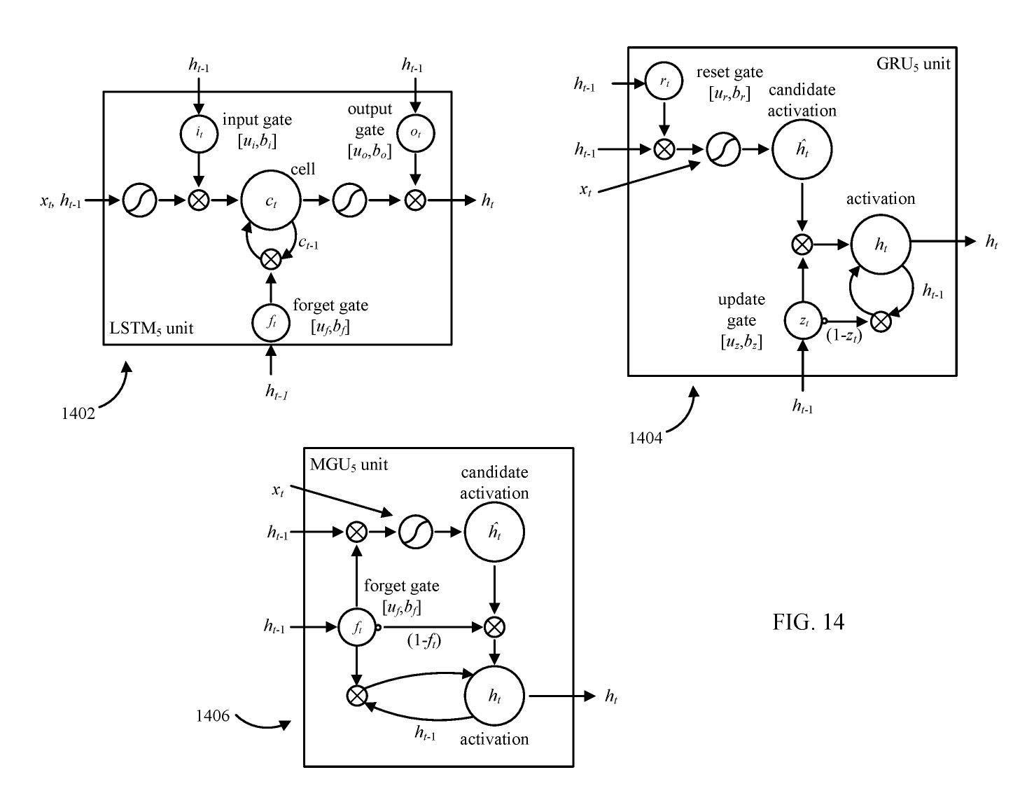

FIG. 14 shows another further example of variants of the RNN units shown in FIG. 4 in accordance with some embodiments of the disclosed subject matter in which a hidden unit can be modified using point-wise multiplication with a vector. As shown in FIG. 14, in some embodiments, the control signals for the various RNNs can include a bias, and the previous hidden state modified using point-wise multiplication, while omitting the weighting matrices W_{*}, and removing reliance on the input vector (e.g., xₜ). For example, LSTM5 unit 1402 is an example implementation of an LSTM unit with reduced gating parameters. In LSTM5 unit 1402, the gating signals can be represented as follows:

iₜ=σ(uᵢ⊙hₜ₋₁+b₁) (48)

fₜ=σ(u_{f}⊙hₜ₋₁+b_{f}) (49)

oₜ=σ(u₀⊙hₜ₋₁+b₀) (50)

As another example, GRUS unit 1404 is an example implementation of a GRU unit with reduced gating parameters. In GRUS unit 1404, the gating signals can be represented as follows:

zₜ=σ(u_{z}⊙hₜ₋₁+b_{z}) (51)

rₜ=σ(uᵣ⊙hₜ₋₁+bᵣ) (52)

As yet another example, MGU5 unit 1406 is an example implementation of a MGU unit with reduced gating parameters. In MGU5 unit 1406, the gating signal can be represented as follows:

fₜ=σ(u_{f}⊙hₜ₋₁+b_{f}) (53)

In the three examples shown in FIG. 14, the number of parameters is reduced by 3n(m+n−1), 2n(m+n−1), and n(m+n−1) parameters, respectively, and for each gating signal two matrix multiplications are eliminated. In the variants described in connection with FIG. 14, the gating signals are reliant on the unit history and a bias vector (e.g., and not reliant on an input vector (e.g., xₜ).

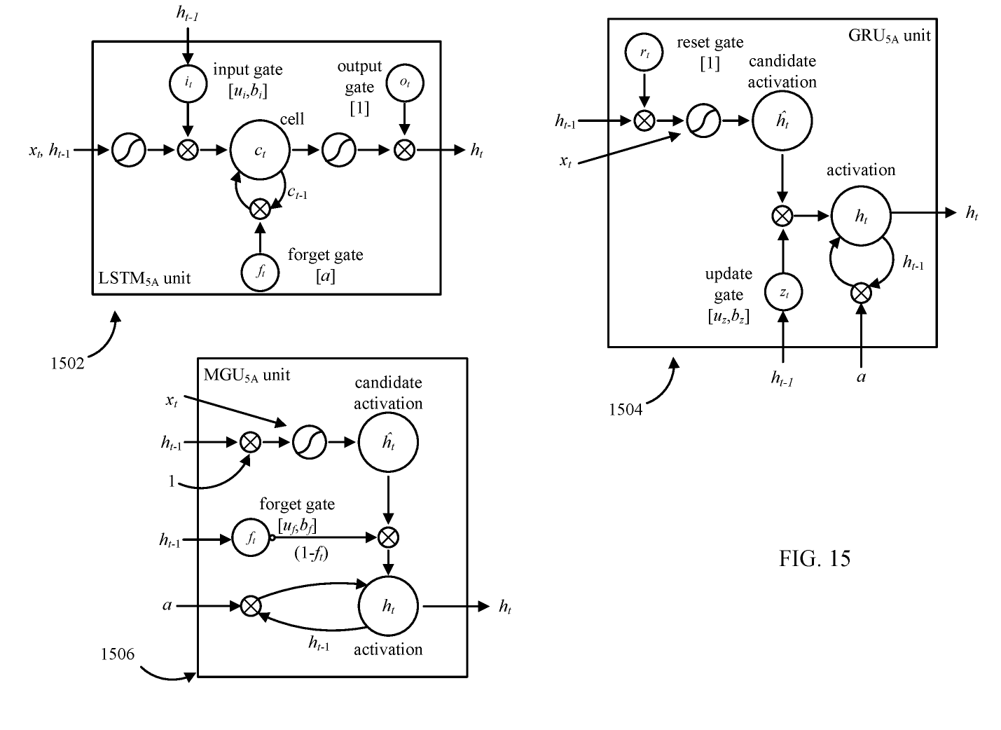

FIG. 15 shows yet another further example of variants of the RNN units shown in FIG. 4 in accordance with some embodiments of the disclosed subject matter in which a hidden unit can be modified using point-wise multiplication with a vector and using scalars as gating signals. As shown in FIG. 15, in some embodiments, the control signals for the various RNNs can include calculating what is sometimes referred to as the input (or alternatively the update) gate using a bias, and the hidden state modified using point-wise multiplication, while omitting the weighting matrices W_{*}, removing reliance on the input vector (e.g., xₜ), and/or replacing one or more gating signals with scalars. For example, LSTM5A unit 1502 is an example implementation of an LSTM unit with reduced gating parameters. In LSTM5A unit 1502, the gating signals can be represented as follows:

iₜ=σ(uᵢ⊙hₜ₋₁+bᵢ) (54)

fₜ=α≤|α|≤1 (55)

Oₜ=1 (56)

Parameter α can be a constant between 0.5 and 0.96 to stabilize the (gated) RNN.

As another example, GRU5A unit 1504 is an example implementation of a GRU unit with reduced gating parameters. In GRU5A unit 1504, the gating signals can be represented as follows:

zₜ=σ(u_{z}⊙hₜ₋₁+b_{z}) (57)

rₜ=1;(1−zₜ)→α, 0≤|α|≥1 (58)

As yet another example, MGU5A unit 1506 is an example implementation of a MGU unit with reduced gating parameters. In MGU5A unit 1506, the gating signal can be represented or assigned as follows:

fₜ=σ(u_{f}⊙hₜ₋₁+b_{f}); (1−fₜ)→α,0≤|60 |≤1 (59)

while now fₜ is set to 1 in association with the output/reset gate.

In the three examples shown in FIG. 15, the number of parameters is reduced for all 3 cases to now become 2 n parameters plus one hyper-parameter to be set as a constant (α). For each gating signal two matrix multiplications are eliminated. In the variants described in connection with FIG. 15, the gating signals are reliant on the unit history and a bias vector (e.g., b_{*}), nut not reliant on the input vector (e.g., xₜ).

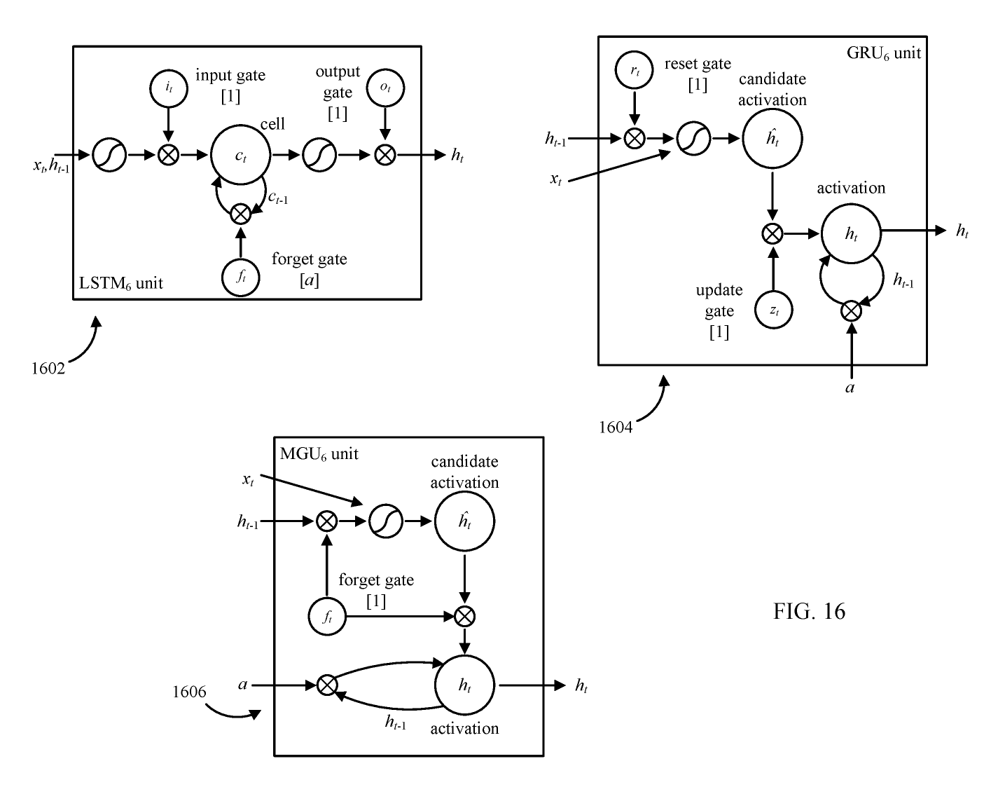

FIG. 16 shows still another further example of variants of the RNN units shown in FIG. 4 in accordance with some embodiments of the disclosed subject matter in which a hidden unit can be modified using scalars as gating signals. As shown in FIG. 16, variants of the control signals for the various RNNs can include using scalars as gating signals, omitting the weighting matrices W_{*}, removing reliance on the input vector xₜ, and removing reliance on the bias vector (b_{*}). For example, LSTM6 unit 1602 is an example implementation of an LSTM unit with reduced gating parameters. In LSTM6 unit 1602, the gating signals can be represented as follows:

iₜ=1 (60)

fₜ=α≤|α|≤1 (61)

Oₜ=1 (62)

As another example, GRU6 unit 1604 is an example implementation of a GRU unit with reduced gating parameters. In GRU6 unit 1604, the gating can be represented or assigned as follows:

zₜ=1 (63)

rₜ=1;(1−zₜ)→α, 0≤|α|≤1 (64)

As yet another example, MGU6 unit 1606 is an example implementation of a MGU unit with reduced gating parameters. In MGU6 unit 1606, the gating signal can be represented or assigned as follows:

fₜ=1;(1−fₜ)→α,0≤|α|≤1 (65)

In the three examples shown in FIG. 16, the number of parameters is reduced for all 3 cases to a single constant hyper-parameter (α). In the variants described in connection with FIG. 16, the gating signals are, in effect, eliminated.

In some embodiments, the overall system equations can represented as:

cₜ=αcₜ₋₁+g(W_{c}xₜ+U_{c}hₜ₋₁+b_{c}) (66)

hₜ=g(cₜ) (67)

Reduction in the memory-cell block: Additionally, in some embodiments, the reduction can be incorporated into the body of the simple RNN (sRNN) network within the original LSTM unit, which can be represented as:

\tilde{c}ₜ=g(W_{c}xₜ+U_{c}hₜ₋₁+b_{c}) (68)

cₜ=fₜ⊙cₜ₋₁+iₜ⊙\tilde{c}ₜ (69)

Note that the external input signal (xₜ) is applied and used for the calculation of \tilde{c}ₜ, although it may be eliminated in the gating signals (e.g., as described above). Additionally, W_{c} (sometimes referred to as a “mixing” matrix), may be necessary for full mixing transformation (e.g., scaling and rotation) of the external signal (input vector) xₜ. In some embodiments, the bias parameter b_{c} may also be necessary, as the external signal may not have a zero mean, on the other hand, optionally it can be removed in some embodiments. However, the n×n-matrix U_{c} can be replaced by an n-dimensional-vector which can retain scaling (e.g., via a point-wise multiplication), but not rotation. Note that over the time horizon propagation, each element within \tilde{c}ₜ will be composed of a weighted sum of all components of the external input signal. Accordingly, “state-vector” Cₜ components can be “mixed” due the mixing of the external input signal. Thus, parameterization can be reduced from n² to n, which can consequently reduce associated update computations and storage for n²-n parameters. For example, a reduction of

$$100 ( 1 - \frac{1}{n} ) / \%$$

can be achieved for this matrix. In a more particular example, for n-d LSTM, this can achieve a 99% reduction.

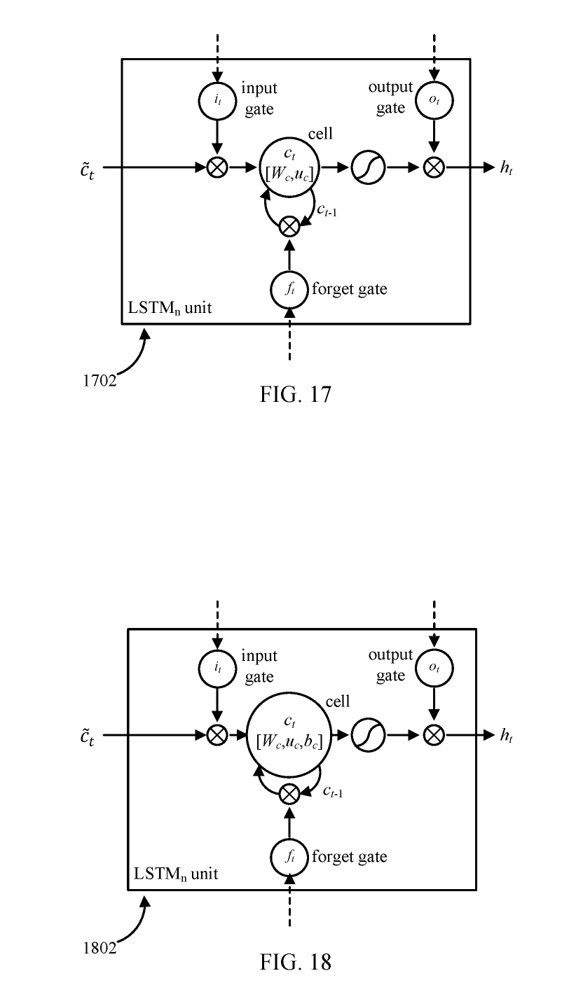

FIG. 17 shows an additional example of variants of the RNN units shown in FIG. 4 in accordance with some embodiments of the disclosed subject matter in which an activation function can be modified using point-wise multiplication with a vector and omitting the bias vector (b_{c}). As shown in FIG. 17, in some embodiments, a variant activation function can be used with various of the RNNs described above, in which the variant can use an n-d vector u_{c} in place of the original n×n-sized matrix U_{c}, and in some cases, the bias vector (e.g., b_{c}) can be removed. In such embodiments, the u_{c} vector can be point-wise (Hadamard) multiplied with the previous hidden activation hₜ₋₁. Note that the bias parameter can be removed in variants described above in connection with FIGS. 6, 12, 13, and 16. In some embodiments, the state vector \tilde{c}ₜ and cell cₜ can be represented as:

\tilde{c}ₜ=g(W_{c}xₜ+u_{c}⊙hₜ₋₁) (70)

cₜ=fₜ⊙c₅₋₁+iₜ⊙\tilde{c}ₜ (71)

FIG. 18 shows another additional example of variants of the RNN units shown in FIG. 4 in accordance with some embodiments of the disclosed subject matter in which an activation function can be modified using point-wise multiplication with a vector. As shown in FIG. 18, in some embodiments, a variant activation function can be used with various RNNs described above, in which the variant can use an n-d vector u_{c} in place of the original n×n-sized matrix U_{c}. In such embodiments, the u_{c} vector can be point-wise (Hadamard) multiplied with the previous hidden activation hₜ₋₁. Note that the bias parameter can be present in variants described above in connection with FIGS. 5, 7, 14 and 15. In some embodiments, the state vector \tilde{c}ₜ and cell cₜ can be represented as:

\tilde{c}ₜ=g(W_{c}xₜ+u_{c}⊙hₜ₋₁+b_{c}) (72)

Cₜ=fₜ⊙cₜ₋₁+iₜ⊙\tilde{c}ₜ (73)

Note that the variants described in connection with FIGS. 17 and 18 are directed toward the “memory cell” (e.g., represented in EQS. (71) and (73). However, these variants can be combined with other LSTM variants (e.g., as described above in connection with FIGS. 5-7 and 12-16).

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above described steps of the process of FIG. 8 can be executed or performed in any order or sequence not limited to the order and sequence shown and described in the figures. Also, some of the above steps of the process of FIG. 8 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by any allowed claims that are entitled to priority to the subject matter disclosed herein. Features of the disclosed embodiments can be combined and rearranged in various ways.

What is claimed is:

1. A method for analyzing data using a reduced parameter gating signal, the method comprising:
receiving input data that includes at least first data and second data, wherein the first data and the second data form at least a portion of a sequence of data and the second data comes after the first data in the sequence;
providing the first data as input to a recurrent neural network, wherein
the recurrent neural network includes at least a first gate corresponding to a first gating signal,
at least a first array of values corresponding to a first parameter in a first equation that is used to calculate values of the first gating signal was calculated based on training data provided to the recurrent neural network, and
the first equation includes not more than two parameters corresponding to arrays of values;
calculating a first value for the first gating signal based on the first equation using the first array of values as the first parameter;
generating a first output based on the first data and the first value for the first gating signal;
providing the second data as input to the recurrent neural network;
generating a second output based on the second data, and the first output; and
providing a third output identifying one or more characteristics of the input data based on the first output and the second output.

2. The method of claim 1, wherein the first parameter is an n×n matrix, and the first output is an n-element vector, wherein n≥1.

3. The method of claim 2, further comprising calculating a second value for the first gating signal based on the first equation using the first parameter and the first output as input data, wherein calculating the second value comprises multiplying the first parameter and the first output.

4. The method of claim 1, wherein the first parameter is an n-element vector, and the first output is an n-element vector, wherein n≥1.

5. The method of claim 1, wherein the recurrent neural network comprises a long short-term memory (LSTM) unit.

6. The method of claim 5, wherein the first gate is an input gate, and the first equation includes neither a weight matrix Wᵢ nor an input vector xₜ.

7. The method of claim 1, wherein the recurrent neural network comprises a gated recurrent unit (GRU).

8. The method of claim 7, wherein the first gate is an update gate, and the first equation does not include a weight matrix W_{z}, an input vector xₜ, nor a bias vector b_{z}.

9. The method of claim 1, wherein the recurrent neural network comprises a minimal gated unit (MGU).

10. The method of claim 9, wherein the first gate is a forget gate, and the first equation includes a bias vector b_{f}, and does not include a weight matrix W_{f}, an input vector xₜ, a weight matrix U_{f}, nor an activation unit hₜ₋₁ generated at a previous step.

11. The method of claim 1, wherein the recurrent neural network uses no more than half as many parameter values as a second recurrent neural network that uses matrices U, W, and b to calculate a gating signal corresponding to the first gating signal.

12. The method of claim 1, wherein the input data is audio data, and the third output is an ordered set of words representing speech in the audio data.

13. The method of claim 1, wherein the input data is a first ordered set of words in a first language, and the third output is a second ordered set of words in a second language representing a translation from the first language to the second language.

14. The method of claim 1, wherein the second output is calculated as hₜ=Oₜ⊙g(cₜ), where g is a non-linear activation function, cₜ is an output of a memory cell of an LSTM unit, Oₜ is an output gate signal, and ⊙ is element-wise (Hadamard) multiplication.

15. The method of claim 1, wherein the recurrent neural network comprises a plurality of LSTM units, and at least one gating signal has a different dimension than an output signal of a memory cell of one of the plurality of LSTM units.

16. The method of claim 1, wherein an update gate signal is a scalar.

17. The method of claim 1, wherein a forget gate signal is a scalar.

18. The method of claim 1, wherein the recurrent neural network includes a memory cell corresponding to a memory cell signal,
at least a second array of values corresponding to a second parameter in a second equation that is used to calculate values of the memory cell signal was calculated based on training data provided to the recurrent neural network,
the second equation includes not more than one parameter corresponding to a multidimensional array of values,
the method further comprising:
calculating a first value for the memory-cell signal; and
generating the first output based on the first data, the first value for the first gating signal, and the first value for the memory-cell signal.

19. A system for analyzing sequential data using a reduced parameter gating signal, the system comprising:
at least one processor that is programmed to:
receive input data that includes at least first data and second data, wherein the first data and the second data form at least a portion of a sequence of data and the second data comes after the first data in the sequence;
provide the first data as input to a recurrent neural network, wherein
the recurrent neural network comprises a long short-term memory (LSTM) unit including at least a first gate corresponding to a first gating signal, and a memory cell corresponding to a memory-cell signal,
a least a first array of values corresponding to a first parameter in a first equation that is used to calculate values of the first gating signal was calculated based on training data provided to the recurrent neural network,
a second array of values corresponding to a second parameter in a second equation that is used to calculate values of the memory-cell signal was calculated based on the training data provided to the recurrent neural network,
the first equation includes not more than two parameters corresponding to arrays of values, and the second equation includes not more than one parameter corresponding to a multidimensional array of values;
calculate a first value for the first gating signal based on the first equation using the first array of values as the first parameter;
calculate a first value for the memory-cell signal based on the second equation using the second array of values as the second parameter;
generate a first output based on the first data, the first value for the first gating signal, and the first value for the memory-cell signal;
provide the second data as input to the recurrent neural network;
generate a second output based on the second data, and the first output; and
provide a third output identifying one or more characteristics of the input data based on the first output and the second output.

20. The system of claim 19, wherein the memory-cell signal is cₜ=fₜ⊙cₜ₋₁+iₜ⊙\tilde{c}ₜ, where fₜ is a forget gate signal, iₜ is an input gate signal, cₜ₋₁ is the first value for the memory-cell signal, \tilde{c}ₜ=g (W_{c}xₜ+u_{c}⊙hₜ₋₁), g is a non-linear activation function, W_{C} is a weight matrix, xₜ is the second data, u_{c} is a weighting vector, hₜ₋₁ is the first output, and ⊙ is element-wise (Hadamard) multiplication.

21. The system of claim 19, wherein the memory cell signal is cₜ=fₜ⊙cₜ₋₁+iₜ⊙\tilde{c}ₜ, where fₜ is a forget gate signal, iₜ is an input gate signal, cₜ₋₁ is the first value for the memory-cell signal, \tilde{c}ₜ=g(W_{c}xₜ+u_{c} ⊙hₜ₋₁+b_{c}), g is a non-linear activation function, W_{c} is a weight matrix, xₜ is the second data, u_{c} is a weighting vector, hₜ₋₁ is the first output, ⊙ is element-wise (Hadamard) multiplication, and b_{c} is a bias vector.
